(19) United States
(12) Patent Application Publication
(10) Pub. No.: US 2021/0374736 A1
(43) Pub. Date: Dec. 2, 2021

(54) WIRELESS BASED METHODS AND SYSTEMS FOR FEDERATED KEY MANAGEMENT, ASSET MANAGEMENT, AND FINANCIAL TRANSACTIONS

(71) Applicants: LAURENCE HAMID, OTTAWA (CA); STEPHEN BORZA, OTTAWA (CA)

(72) Inventors: LAURENCE HAMID, OTTAWA (CA); STEPHEN BORZA, OTTAWA (CA)

(21) Appl. No.: 17/393,603

(22) Filed: Aug. 4, 2021

Related U.S. Application Data
(62) Division of application No. 16/237,960, filed on Jan. 2, 2019.
(60) Provisional application No. 62/612,877, filed on Jan. 2, 2018.

(51) Int. Cl. G06Q 20/38; G06Q 20/20; G06Q 20/32

(52) U.S. Cl. CPC G06Q 20/3829; G06Q 20/202; G06Q 20/3274; G06K 19/06037; G06Q 20/325; G06Q 20/3278; G06Q 2220/00; G06Q 20/204

(57) ABSTRACT

Short-range wireless protocols whilst leveraging enhanced security protocols, encryption techniques, and range raises alternate issues. For example, a user's smartphone would identify all the checkout POS terminals within range whilst the checkout POS terminal would identify all Bluetooth enabled devices within range. Accordingly, it would be beneficial to provide solution that allow for connection between a defined PED and a defined POS terminal within an overall environment of multiple PEDs and POS terminals. It would be further beneficial for the solution to remove the requirements of selecting PEDs and/or POS terminals and the ability to establish a connection between a predetermined device, e.g. a POS terminal or asset, amongst multiple POS terminals or assets. Accordingly, once a secure connection between the user's device and the POS terminal or asset is established the POS terminal or asset can then validate a key received from the user's device to authorize a transaction or an action relating to the asset.

### CROSS-REFERENCE TO RELATED APPLICATIONS

This application claims the benefit of priority as a divisional application of U.S. patent application Ser. No. 16/237,960 filed Jan. 2, 2019; which itself claims the benefit of priority from U.S. Provisional Patent Application 62/612,877 filed Jan. 2, 2018, the entire contents of which are incorporated herein by reference.

### FIELD OF THE INVENTION

This invention relates to asset management and financial transactions and more particularly to methods and systems for federated key management facilitating secure asset management and financial transactions within environments with high densities of wirelessly enabled assets, terminals, users etc. or where flexibility in asset location is beneficial.

### BACKGROUND OF THE INVENTION

Today wireless and wired telecommunications networks have established ubiquitous connectivity for a wide range of consumer electronic devices, including, but not limited to, smartphones, laptops, tablets, smartwatches, fitness trackers, navigation systems, gaming systems, and entertainment systems to a wide range of consumer and professional electronic devices, services and enterprises hosted on remote servers accessed via these telecommunications networks. By 2020 the number of smartphones alone is expected to exceed 6 billion, used by approximately 70% of the global population, with wireless interfaces, Internet access, and data services with high definition displays, integral camera(s), global positioning system (GPS), multiple sensors (accelerometer, temperature, and humidity for example), as well as wired and wireless audio interfaces. However, these are expected to represent only approximately 25% of the total number of wirelessly connected devices in use by the global population at that time.

Naturally, as the capabilities of these devices has increased then their applications have expanded to include mobile banking where the user can perform a wide range of financial activities on their portable wirelessly connected device, mobile purchasing via online portals and webpages etc. as well as mobile based payments to Point-of-Sale (POS) terminals, kiosks, vending systems etc. Accordingly, these intelligent and mobile computing and wireless connected devices are now part of evolving financial and commercial ecosystems that are merging with these devices already existing information gathering and processing capabilities. Equally, the capabilities of the mobile wireless connected devices can vary according to the financial process as mobile banking and purchasing typically exploit wireless access to the Internet via one or more wireless (e.g. Bluetooth, Wi-Fi, WiMAX, and cellular) and wired networks whereas POS exploits Near-Field-Communications (NFC) wherein NFC capabilities established for physical cards (commonly referred to as contactless cards).

Already, an array of multi-national corporations and organizations such as Apple™, Google™, Samsung™, MasterCard™ etc. are all vying to democratize access to and paying for goods and services with either their electronic devices or software applications yet control and exploit the information acquired as a result which is personalized lifestyle information for each buyer. This process has not gone unhindered however, since multiple obstacles exist some which are beyond the reach of their control. For example, the possibility of performing a Near-Field-Communication (NFC) payments is not dictated by the buyer's device, but by the POS terminal which is requesting the transaction on the merchant-side of the transaction. In January 2016 only 20% of all operated NFC-capable POS terminals in Canada had the functionality enabled and by the end of 2016 whilst the majority of new European and North American POS terminals were NFC-enabled this figure drops globally. NFC payments have also experienced consumer reluctance/hesitation arising from both a lack of knowledge pertaining to the technology, the security which supports an NFC transaction, and media highlighting how NFC cards can be easily read even whilst in the user's pocket or handbag.

However, irrespective of these factors fundamentally NFC payments require that the user and the NFC reader linked to the POS terminal are brought within close proximity to one another. Typically, user's will actually tap their NFC enabled card or PED against the NFC reader. Technically, NFC systems should function according to the standards, such as ISO/IEC 18000-3:2010, ISO/IEC 18092, ISO/IEC 21481 and NFC Forum Technical Specifications Release 2017 for example, with a separation of 10 cm or less (4 inches or less) operating at 13.56 MHz on an ISO/IEC 18000-3 air interface at rates ranging from 106 kbit/s to 424 kbit/s. However, this requirement for close physical proximity can be inconvenient for the customer during the transaction, require placement of an NFC reader the customer can easily access (impacting ergonomics of POS terminals, checkouts, vending machines etc. as well as requiring environmental protection in external environments etc.), etc. Further, NFC systems are not immune to attack.

Although the range of NFC is limited to a few centimeters (an inch or so) NFC communications do not ensure secure communications. For example, it is known in the prior art to leverage NFC's resistance to man-in-the-middle attacks to establish a specific key. As this technique is not part of the ISO standard, NFC offers no protection against eavesdropping and can be vulnerable to data modifications requiring applications to exploit higher-layer cryptographic protocols (e.g. SSL) to establish a secure channel. Further, whilst the user's NFC device and the NFC terminal must be within a few centimeters (an inch or so) the RF signal for the wireless data transfer can be picked up with antennas and the distance from which an attacker is able to eavesdrop the RF signal, whilst depending on multiple parameters, is typically less than 10 meters (approximately 30 feet) for active devices and less than 1 meter (approximately 3 feet). Further, NFC devices usually include ISO/IEC 14443 protocols, against which relay attacks are feasible wherein the adversary forwards the request of the reader to the victim and relays its answer to the reader in real time, pretending to be the owner of the victim's smart card. Akin to a man-in-the-middle attack this can be undertaken with stock commercial NFC devices such as NFC-enabled mobile phones.

However, exploiting other short-range wireless communication protocols, such as Bluetooth™ or Wi-Fi (IEEE 802.11) for example, within applications currently the domain of NFC such as POS transactions etc. thereby leveraging enhanced security protocols, encryption techniques, and range raises alternate issues. For example, in most POS applications a user's smartphone, for example, would identify all the checkout POS terminals within range whilst the checkout POS terminal would identify all Bluetooth enabled devices within range. Accordingly, it would be beneficial to provide a solution that allows for a connection to be established uniquely between a defined PED and a defined POS terminal within an overall environment of multiple PEDs and POS terminals. It would be further beneficial for the solution to remove the requirements of selecting PEDs and/or POS terminals, for example, by selecting from displayed lists of available POS terminals and PEDs respectively.

It would also be beneficial to provide a user with the ability to establish a connection between a predetermined device, e.g. a POS terminal, amongst multiple POS terminals by providing the POS terminal with a first portion of a pairing code which it broadcasts and a user's device with a second portion of the pairing code allowing the user's device to selectively pair to the POS terminal with the other portion of the matching pairing code. Accordingly, a secure connection between the user's device and a specific POS terminal can be established to facilitate a transaction and/or communications even when the environment is “crowded” with electronic devices and/or POS terminals.

It would also be beneficial to provide a user with the ability to establish a connection between a predetermined device, e.g. an asset, amongst multiple assets by providing the asset with a first portion of a pairing code which it broadcasts and a user's device with a second portion of the pairing code allowing the user's device to selectively pair to the asset with the other portion of the matching pairing code. Accordingly, a secure connection between the user's device and a specific asset can be established to facilitate a transaction, access to the asset, unlocking the asset, communications etc. even when the environment is “crowded” with electronic devices and/or assets.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to asset management and financial transactions and more particularly to methods and systems for federated key management facilitating secure asset management and financial transactions within environments with high densities of wirelessly enabled assets, terminals, users etc. or where flexibility in asset location is beneficial.

In accordance with an embodiment of the invention there is provided a method of establishing a wireless association comprising:
providing a point of sale terminal (POST) comprising a first wireless transceiver operating according to a predetermined wireless protocol and a camera;
providing a portable electronic device (PED) comprising a second wireless transceiver operating according to the predetermined wireless protocol and a display;
generating upon the display of the PED an optical machine-readable code comprising first data relating a discoverable identity of the second wireless transceiver in response to an input to the PED;
capturing the optical machine-readable code with the camera and extracting the first data; and
configuring a process with respect to the first wireless transceiver in dependence upon the first data; wherein
the first wireless transceiver and the second wireless transceiver form a wireless network.

In accordance with an embodiment of the invention there is provided a method of establishing a wireless association comprising:
providing a point of sale terminal (POST) comprising a first wireless transceiver operating according to a predetermined wireless protocol and a display;
providing a portable electronic device (PED) comprising a second wireless transceiver operating according to the predetermined wireless protocol and a camera;
generating upon the display of the POST an optical machine-readable code comprising first data relating a discoverable identity of the first wireless transceiver;
capturing the optical machine-readable code with the camera and extracting the first data; and
configuring a process with respect to the second wireless transceiver in dependence upon the first data; wherein
the first wireless transceiver and the second wireless transceiver form a wireless network.

In accordance with an embodiment of the invention there is provided a method comprising:
determining that a product associated with a point-of-sale (POS) transaction being performed upon a point-of-sale terminal (POST) relates to a product having a minimum age restriction;
capturing an image of a user with a camera forming part of the POST;
obtaining personal identifiable information comprising an electronic validated image of the user in dependence upon one or more wireless communications between the POST and a portable electronic device (PED) associated with a user wishing to by the product;
performing a matching process with the captured image and the electronic validated image and determining whether the matching process exceeds a threshold; and upon a positive determination enabling the POS transaction with respect to the product having a minimum age restriction;
upon a negative determination triggering an action.

In accordance with an embodiment of the invention there is provided a method comprising:
storing a locked asset upon a server connected to a communications network, the locked asset comprising an encrypted version of an asset which was encrypted with a content key;
storing in association with the locked asset an encrypted version of the content key and an identity of an owner of the asset;
receiving from a requestor within a first software application in execution upon a first electronic device a request to access the locked asset, the first electronic device associated with the requestor;
transmitting to the owner of the asset a first electronic message via the communications network, the first message comprising first data relating to an identification of the locked asset, the encrypted content key, and second data relating to an identification of the requestor;
displaying within a graphical user interface of a second software application in execution upon a second electronic device the first data and the second data together with a button relating to an approval of the owner of the asset for the requestor to access the locked asset, the second electronic device associated with the owner of the asset;
determining whether the owner of the asset has approved the requestor's request to access the locked asset; and
   upon a positive determination performing the additional steps of:
decrypting the encrypted version of the content key with a decryption key associated with the owner of the asset to regenerate the content key; and
transmitting a second electronic message via the communications network from the second electronic device to the first electronic device, the second electronic message comprising the content key.

In accordance with an embodiment of the invention there is provided a method comprising:
providing a first electronic device comprising a wireless interface operating according to a predetermined protocol, the first electronic device forming part of or attached to an asset and coupled to a communications network;
providing within a server coupled to the communications network a software application for managing access to the asset;
receiving a request from a requestor relating to accessing the asset at a predetermined time;
transmitting from the server to the first device first data relating to predetermined time and second data relating to a pairing code for establishing a secure connection between the first electronic device and a second electronic device associated with the requestor, the second electronic device comprising a wireless interface operating according to the predetermined protocol;
transmitting from the server to the second electronic device third data relating to the pairing code and fourth data relating to a key to access the asset;
transmitting from the first electronic device at the predetermined time an advertisement advertising its presence;
monitoring with the second electronic device for the advertisement from the first device;
determining whether the advertisement from the first electronic device is received by the second electronic device and upon a positive determination providing an indication to a user of the second electronic device;
receiving from the user of the second electronic device the third data relating to the pairing code; and
establishing a secure connection between the first electronic device and the second electronic device in dependence upon the second data relating to the pairing code and the third data relating to the pairing code relating to the same pairing code;
transmitting to the first electronic device from the second electronic device the key;
validating the key upon the second electronic device and upon determinations of a valid key performing a predetermined action with respect to the asset.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a wireless portable electronic device supporting communications to a network such as depicted in FIG. 1 and as supporting embodiments of the invention;

FIG. 3A depicts examples of retail checkouts and NFC enabled Point-of-Sale (POS) terminals;

FIG. 3B depicts an exemplary retail environment with an array of POS terminals together with a diagrammatic comparison of NFC and Bluetooth™ PEDs relative to such an array of POS terminals;

FIG. 4A depicts schematically an exemplary sequence for associating a PED and POS terminal via a short-range wireless protocol according to an embodiment of the invention:

FIG. 4B depicts schematically an exemplary sequence for associating a PED and POS terminal via a short-range wireless protocol according to an embodiment of the invention;

FIGS. 5 to 8 depict exemplary process flows for associating a PED and POS terminal via a short-range wireless protocol according to an embodiment of the invention;

FIG. 9 depicts an exemplary process flow for a financial process exploiting embodiments of the invention;

FIG. 10 depicts an exemplary sequence for performing an age verified transaction at a self-service POS terminal according to an embodiment of the invention;

FIG. 11 depicts an exemplary process flow for associating a PED and a self-service POS terminal via a short-range wireless protocol and performing an age verified transaction at the self-service POS terminal according to an embodiment of the invention;

FIG. 12 depicts an exemplary process flow for providing access to an asset for a requesting user by the asset's owner within an asset management application providing controlled access to assets according to an embodiment of the invention; and

FIG. 13 depicts an exemplary webpage presented to a user seeking to access an asset, in this instance a car, wherein the subsequent access to the asset is controlled by processes according to one or more embodiments of the invention.

### DETAILED DESCRIPTION

The present invention is directed to asset management and financial transactions and more particularly to methods and systems for federated key management facilitating secure asset management and financial transactions within environments with high densities of wirelessly enabled assets, terminals, users etc. or where flexibility in asset location is beneficial.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users. Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “portable electronic device” (PED) or “mobile electronic device” (commonly referred to as a mobile) as used herein and throughout this disclosure, refers to a wireless device used for communications and other applications that requires a battery or other independent form of energy for power. A PED may be recharged from a fixed interface to obtain power and also be connected to a wired communications interface. This includes devices, but is not limited to, such as a cellular telephone, smartphone, personal digital assistant (PDA), portable computer, pager, portable multimedia player, portable gaming console, a navigation system, laptop computer, tablet computer, a wearable device, an implanted device, a smart card, portable POS, mobile POS (mPOS), a motorized vehicle, a non-motorized vehicle, public transit vehicle, a vehicle guided by tracks and/or rails, an aircraft, a lighter-than-air device, a drone, a robot, an android, a biomedical device, an item of medical equipment and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a terminal, a gaming console, a digital set-top box, a base station, a wireless network access node/point, a network device, an automated teller machine (ATM), an automated banking machine (ABM), an analog set-top box, an Internet enabled appliance, an Internet enabled television, a POS terminal, a vending machine, a self-service device or system, a robotic system, an item of medical equipment, an entertainment system and a multimedia player.

A “computer server” (commonly known as a server) as used herein, and throughout this disclosure, refers to one or more physical computers co-located and/or geographically distributed running one or more services as a host to users of other computers, servers, PEDs, FEDs, etc. to serve the client needs of these other users. This includes, but is not limited to, a database server, file server, mail server, print server, web server, gaming server, virtual environment server, utility provider server, service provider server, goods provider server, financial server, financial registry server, personal server, and a Government regulatory server.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED, FED and/or server.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook™, Google+™, Tumblr™ and Twitter™; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility provider, a financial provider and a service provider. Such enterprises may be directly owned and controlled by a company or may be owned and operated by a franchisee under the direction and management of a franchiser.

A “service provider” as used herein may refer to, but is not limited to, a third-party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of service providers, members of a financial registry, members of utility providers, members of retailers, members of organizations, members of charities, men, women and children. In its broadest sense the user may further include, but not be limited to, software systems, mechanical systems, robotic systems, android systems, etc. that may be characterised by an ability to exploit one or more embodiments of the invention. A user may be associated with biometric data which may be, but not limited to, monitored, acquired, stored, transmitted, processed and analysed either locally or remotely to the user. A user may also be associated through one or more accounts and/or profiles with one or more of a service provider, third party provider, enterprise, social network, social media etc. via a dashboard, web service, website, software plug-in, software application, and graphical user interface.

“User information” as used herein may refer to, but is not limited to, user behavior information, user profile information, and personal information. It may also include a user's biometric information, an estimation of the user's biometric information, or a projection/prediction of a user's biometric information derived from current and/or historical biometric information, and current—historical profile information.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Quantified self” as used herein may refer to, but is not limited to, the acquisition and storage of data relating to a user's daily life in terms of inputs (e.g. food consumed, quality of surrounding air), states (e.g. mood, arousal, blood oxygen levels), and performance (mental and physical). Acquisition of data may be combine wearable sensors (EEG, ECG, video, etc.) and wearable computing together with audio, visual, audiovisual and text based content generated by the user.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “wares provider” and/or “service provider” as used herein and through this disclosure refers to, but is not limited to, a provider of wares (goods/products) and/or services (direct/indirect) to a user or on behalf of a user. This includes, but is not limited to, retailers, stores, shops, utilities, network operators, service providers, and charities.

A “subscription” as used herein and through this disclosure refers to, but is not limited to, a financial transaction. This includes, but is not limited to, annual contracts, fixed term contracts, pay-per-use activities, etc. A purchase may be considered within embodiments of the invention as a subscription with a single occurrence.

A “financial registry” as used herein and through this disclosure refers to, but is not limited to, a database of customer and/or subscriber information relating to finances including, but not limited to, financial instruments such as credit cards, debit cards, and gift cards for example; financial services such as loans, mortgages, and banking for example; and financial accounts such as those relating to checking, savings, mortgage, line of credit, shares, and Government regulated savings.

A “registered party” as used herein may refer to a person, group, or organization that has registered with a financial registry and may or may not be the intended recipient of monies or intended provider of monies associated with a financial transaction.

A “financial provider” as used herein may refer to any provider of financial services, either online and/or in a traditional physical location including, but not limited to, credit, debit, and loan services against which financial charges are made arising from periodic and/or aperiodic transactions relating to a user and/or registered party.

An “External World” as used herein and through this disclosure refers to, but is not limited to, an environment within which a transaction between a user and a wares provider and/or service provider is executed resulting in a financial commitment between the user and the wares provider and/or service provider on a discrete and/or recurring basis with respect to the provisioning of at least one of a ware, wares, goods, a good, a product, products, a service, and services to the user by the wares provider and/or service provider. Accordingly, the “External World” includes, but is not limited to, servers, systems, and equipment relating to at least one of the wares provider(s), service provider(s), and financial provider(s) storing and managing aspects of the associated provider including, but not limited to, financial registries, service registries, user registries, security registries, credential registries, user registries, service agreements, service level agreements, and contracts. The “External World” may also include, but is not limited to, systems and equipment relating to the user including, but not limited to, PED(s) and FED(s) to which wares and/or services are provided.

A “financial transaction” or “transaction” as used herein and through this disclosure refers to, but is not limited to, an exchange for at least one of goods and/or services in exchange for remuneration, typically, financial remuneration in one or more currencies.

“Electronic Business” (e-business) as used herein and through this disclosure refers to, but is not limited to, any kind of business or commercial transaction that includes sharing information across the Internet. E-business may include, but is not limited to, P2P, C2B, B2B, C2G, and B2G.

A “person-to-person” (P2P) transaction or business model refers to transactions and/or business between one person to another person or alternatively between two entities each selected from the group comprising an organism, a person, a consumer, a user, an android and an autonomous robotic system. P2P transactions are also part of a wider known class of transactions known as “customer-to-customer” (C2C) transactions.

A “consumer-to-business” (C2B) transaction or business model refers to transactions and/or business between a consumer (individual) and a business wherein the transaction may be from the consumer to the business or from the business to the consumer. Accordingly, it refers to one or more transactions wherein one participant is considered a consumer, and the other a corporate or merchant entity.

A “business-to-business” (B2B) transaction or business model refers to transactions and/or business between a first business and a second business wherein the transaction may be from the first business to the second business or from the second business to the first business.

A “consumer-to-government” (C2G) and/or “business-to-government” (B2G) transaction or business model refers to transactions and/or business between a consumer (individual) or a business and a government wherein the transaction may be from the consumer/business to the government or from the government to the business and/or consumer. Accordingly, it refers to one or more transactions wherein one participant is considered a consumer or corporate/merchant entity and the other is a government entity.

A “person-to-device” (P2D) and/or “device-to-device” (D2D) transaction or business model refers to transactions and/or business between a person (individual) and a device or a first device and a second device respectively. The transaction may be from either party to the other as a discrete transaction or as part of a series of transactions.

“Geolocation” as used herein refers to, but is not limited, to the identification or estimation of the real-world geographic location of an object. In its simplest form geolocation involves the generation of a set of geographic coordinates and is closely related to the use of positioning systems, such as global positioning systems (GPS). However, other non-satellite based systems may be employed including for example geolocating or positioning based upon a location engine exploiting wireless/radio frequency (RF) location methods such as Time Difference of Arrival (TDOA) where such information is accessible from multiple wireless transponders to allow triangulation. Alternatively, wireless base stations/cell towers can be employed to triangulate the approximate position through timing/power information of the multiple wireless base stations/cell towers which whilst subject to many sources of error beneficially supports indoor environments as well as outdoor environments where GPS satellite signals are weak or blocked. Other geolocation methods can include Internet and computer geolocation by associating a geographic location with the Internet Protocol (IP) address, MAC address, RFID, Wi-Fi access node etc. IP address location data can include information such as country, region, city, postal/zip code, latitude, longitude and time zone. Geolocation data may be defined in international standards such as ISO/IEC 19762-5:2008 or as defined by other standards or proprietary formats.

“Encryption” (also referred to as encrypting) as used herein may refer to, but is not limited to, the process of encoding electronic content with the intention that only authorized parties (recipients) can read it. “Decryption” (also referred to as decrypting) as used herein may refer to, but is not limited to, the process of un-encoding electronic content with the intention that an authorized parties (recipients) can read it, wherein the electronic content has previously been encoded through an encryption technique. Encryption and decryption techniques may include, but are not limited to, symmetric encryption schemes wherein the encryption and decryption keys are the same such that the communicating parties must have the same key before they can achieve secret communication and asymmetric encryption schemes (also known as public-key encryption schemes) wherein the encryption key is published for anyone to use and encrypt messages but only the receiving party has access to the decryption key that enables messages to be read. Examples of symmetric key schemes include, but are not limited to, Advanced Encryption Standard (AES), Blowfish, Data Encryption Standard, Serpent, Twofish, and RC4 as well as others (see for example http://en.wikipedia.org/wiki/Symmetric-key_algorithm).

Examples of asymmetric key schemes include, but are not limited to, Diffie-Hellman key exchange, Digital Signature Standard, ElGamal, elliptic curve cryptography. Password-authenticated key agreements, Paillier cryptosystems, RSA, YAK, and Cramer-Shoup cryptosystem.

A “Quick Response” (QR) code is a two-dimensional (2D) barcode which is a 2D pattern providing an optical, machine-readable, representation of data. Such QR codes may be established at a variety of data types (mode or input character set), versions (i.e. overall dimensions), and error correction levels. It would also be evident that data may be encoded within only a portion or predetermined portions of a QR code whilst the remainder of the QR code may be obfuscating code. Optionally, a single QR code may be employed with multiple users wherein due to the settings of their application it is targeted at a different section of the QR code. Optionally, multiple QR codes may be employed to sequentially provide data. In addition to QR codes it would be evident that other types of matrix barcode and linear barcodes may be employed including, but not limited to, the alternative linear barcodes and two-dimensional (2D or matrix) barcode symbologies may be found listed in Wikipedia, see http://en.wikipedia.org‘wiki’Barcode #Symbologies, and within the references referred to therein.

Exemplary Network Architectures and Devices

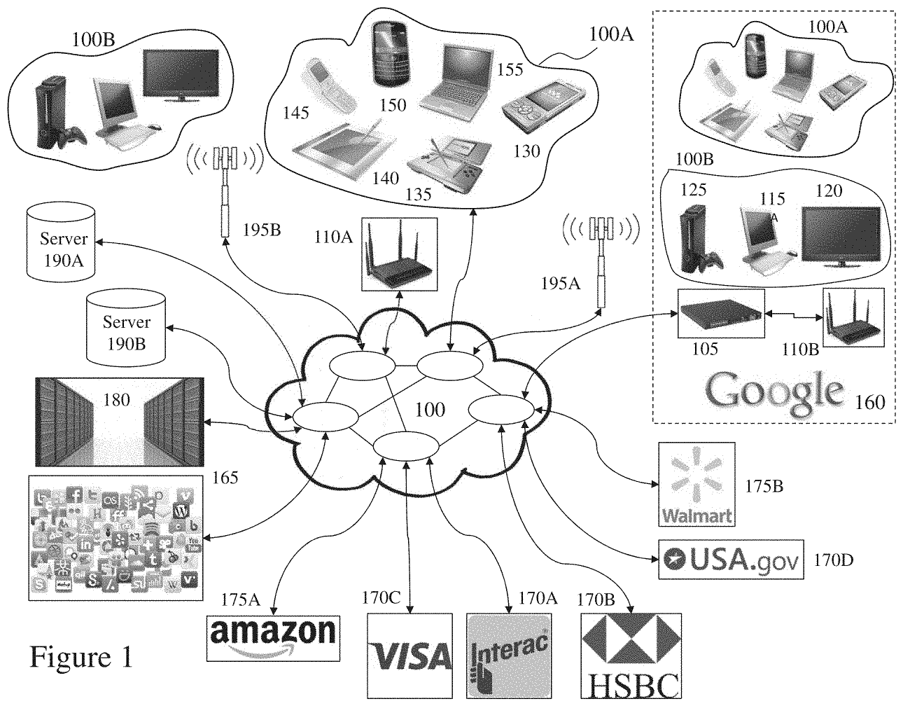

Referring to FIG. 1 there is depicted a network environment 100 within which embodiments of the invention may be employed supporting Financial Transaction Systems and Financial Transaction Applications/Platforms (FTS-FTAPs) according to embodiments of the invention. Such FTS-FTAPs, for example, supporting multiple communication channels, dynamic filtering, etc. As shown first and second user groups 100A and 100B respectively interface to a telecommunications network environment 100. Within the representative telecommunication architecture, a remote central exchange 180 communicates with the remainder of a telecommunication service providers network via the network environment 100 which may include for example long-haul OC-48/OC-192 backbone elements, an OC-48 wide area network (WAN), a Passive Optical Network, and a Wireless Link. The central exchange 180 is connected via the network environment 100 to local, regional, and international exchanges (not shown for clarity) and therein through network environment 100 to first and second cellular APs 195A and 195B respectively which provide Wi-Fi cells for first and second user groups 100A and 100B respectively. Also connected to the network environment 100 are first and second Wi-Fi nodes 110A and 110B, the latter of which being coupled to network environment via router 105. Second Wi-Fi node 1101B is associated with commercial service provider 160, e.g. Googlem, comprising other first and second user groups 100A and 100B. Second user group 100B may also be connected to the network environment 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network environment 100 through multiple APs, not shown for clarity, distributed geographically by the network operator or operators. First cellular AP 195A as show provides coverage to first user group 100A and environment 160, which comprises second user group 100B as well as first user group 100A. Accordingly, the first and second user groups 100A and 100B may according to their particular communications interfaces communicate to the network environment 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 and Bluetooth as well in an ad-hoc manner.

Also connected to the network environment 100 are Social Networks (SOCNETS) 165, first and second service providers 170A and 170B respectively, e.g. Interac™ and HSBC™ first and second third party service providers 170C and 170D respectively, e.g. Visa™ and USA.gov™. Also connected to the network environment 100 are first and second retailers 175A and 175B respectively, e.g. Amazon™ and Walmart™, together with others, not shown for clarity. Also depicted are first and second servers 190A and 190B which may host according to embodiments of the inventions multiple services associated with a provider of Financial Transaction Systems and Financial Transaction Applications/Platforms (FTS-FTAPs); a provider of a SOCNET or Social Media (SOME) exploiting FTS-FTAP features; a provider of a SOCNET and/or SOME not exploiting FTS-FTAP features; a provider of services to PEDS and/or FEDS; a provider of one or more aspects of wired and/or wireless communications; an Enterprise 160 such as Google™ exploiting FTS-FTAP features; license databases; content databases; image databases; content libraries; customer databases; websites; and software applications for download to or access by FEDs and/or PEDs exploiting and/or hosting FTS-FTAP features. First and second primary content servers 190A and 190B may also host for example other Internet services such as a search engine, financial services, third party applications and other Internet based services.

Accordingly, a consumer and/or customer (CONCUS) may exploit a PED and/or FED within an Enterprise 160, for example, and access one of the first or second primary content servers 190A and 190B respectively to perform an operation such as accessing/downloading an application which provides FTS-FTAP features according to embodiments of the invention; execute an application already installed providing FTS-FTAP features; execute a web based application providing FTS-FTAP features; or access content. Similarly, a CONCUS may undertake such actions or others exploiting embodiments of the invention exploiting a PED or FED within first and second user groups 100A and 100B respectively via one of first and second cellular APs 195A and 195B respectively and first Wi-Fi nodes 110A. It would also be evident that a CONCUS may, via exploiting network environment 100 communicate via telephone, fax, email, SMS, social media, etc.

Accordingly, FIG. 1 depicts a network environment 100 wherein one or more parties including, but not limited to, a user, users, an enterprise, enterprises, third party provider, third party providers, wares provider, wares providers, financial registry, financial registries, financial provider, and financial providers may engage in one or more financial transactions relating to an activity including, but not limited to, e-business, P2P, C2B, B2B, C2C, B2G, C2G, P2D, and D2D.

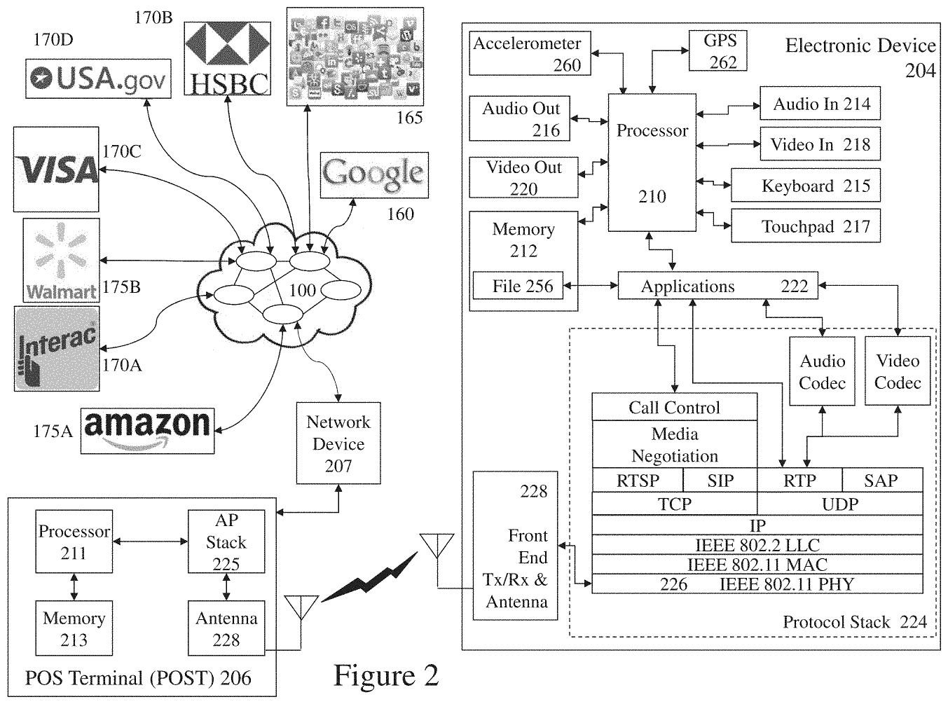

Now referring to FIG. 2 there is depicted an electronic device 204 and network device 207 supporting FTS-FTAP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a smartphone 155, a Point-of-Sale (POS) Terminal (POST) 206, and one or more network devices 207, such as communication servers, streaming media servers, and routers for example such as first and second servers 190A and 190B respectively. Network devices 207 may be coupled to POST 206 via any combination of networks, wired, wireless and/or optical communication links such as discussed above in respect of FIG. 1 as well as directly as indicated. Network devices 207 are coupled to network environment 100 and therein Social Networks (SOCNETS) 165, first and second service providers 170A and 170B respectively, e.g. Interac™ and HSBC™ first and second third party service providers 170C and 170D respectively, e.g. Visa™ and USA.gov™. Also connected to the network environment 100 are first and second retailers 175A and 175B respectively, e.g. Amazon™ and Walmart™, together with others, not shown for clarity.

The electronic device 204 includes one or more processors 210 and a memory 212 coupled to processor(s) 210. POST 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 204 may include an audio input element 214, for example a microphone, and an audio output element 216, for example, a speaker, coupled to any of processors 210. Electronic device 204 may include a video input element 218, for example, a video camera or camera, and a video output element 220, for example an LCD display, coupled to any of processors 210. Electronic device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the electronic device 204. The one or more applications 222 that are typically stored in memory 212 and are executable by any combination of processors 210. Electronic device 204 also includes accelerometer 260 providing three-dimensional motion input to the processor 210 and GPS 262 which provides geographical location information to processor 210.

Electronic device 204 includes a protocol stack 224 and POST 206 includes a communication stack 225. Within the system 200 a protocol stack 224 is shown as IEEE 802.11 protocol stack but alternatively may exploit other protocol stacks such as an Internet Engineering Task Force (IETF) multimedia protocol stack for example. Likewise, POST stack 225 exploits a protocol stack but is not expanded for clarity. Elements of protocol stack 224 and POST stack 225 may be implemented in any combination of software, firmware and/or hardware. Protocol stack 224 includes an IEEE 802.11-compatible PHY module 226 that is coupled to one or more Front-End Tx/Rx & Antenna 228. Applications 222 may be able to create, maintain and/or terminate communication sessions with any of Network Devices 207 by way of POST 206. Typically, applications 222 may activate a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, as well as media negotiation and call control modules.

It would be apparent to one skilled in the art that elements of the electronic device 204 may also be implemented within the POST 206 including but not limited to one or more elements of the protocol stack 224, including for example an IEEE 802.11-compatible PHY module, an IEEE 802.11-compatible MAC module, and an IEEE 802.2-compatible LLC module. The POST 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, FIG. 2 depicts an Electronic Device 204, e.g. a PED, wherein one or more parties including, but not limited to, a user, users, an enterprise, enterprises, third party provider, third party providers, wares provider, wares providers, financial registry, financial registries, financial provider, and financial providers may engage in one or more financial transactions relating to an activity including, but not limited to, e-business, P2P, C2B, B2B, C2C, B2G, C2G, P2D, and D2D via the network environment 100 using the electronic device or within either the access point 206 or network device 207 wherein details of the transaction are then coupled to the network environment 100 and stored within remote servers.

Embodiments of the invention allow the establishment of wireless POS transactions at distances not supported by NFC protocols by enabling association of the POS Terminal and PED within environments wherein multiple POS Terminals are within range of the PED and multiple PEDs are within range of each POS Terminal. Accordingly, once the association is enabled the enhanced transmission capabilities, link duration, security etc. of the wireless protocol can be leveraged to support the POS transaction and/or perform electronic verification of user attributes such as age for POS transactions relating to age restricted products such as alcohol, tobacco, recreational drugs, pharmaceuticals, adult magazines etc. It would also be evident that whilst embodiments of the invention describe a financial transaction undertaken between two electronic devices, a PED and a POS Terminal, it would be evident that the methods and systems may be employed in a variety of applications as well as transactions involving two or more devices, generalized as an N-device transaction wherein authorization of the transaction requires not only the POS Terminal, the user's PED but one or more other devices to authorize, e.g. a parent to authorize a transaction by a son or daughter or a manager to authorize a sale etc. In other embodiments of the invention multiple PEDs may be required to be associated with a POS Terminal for the transaction to be performed.

Asset—Device Pairing Based Upon Visual Codes

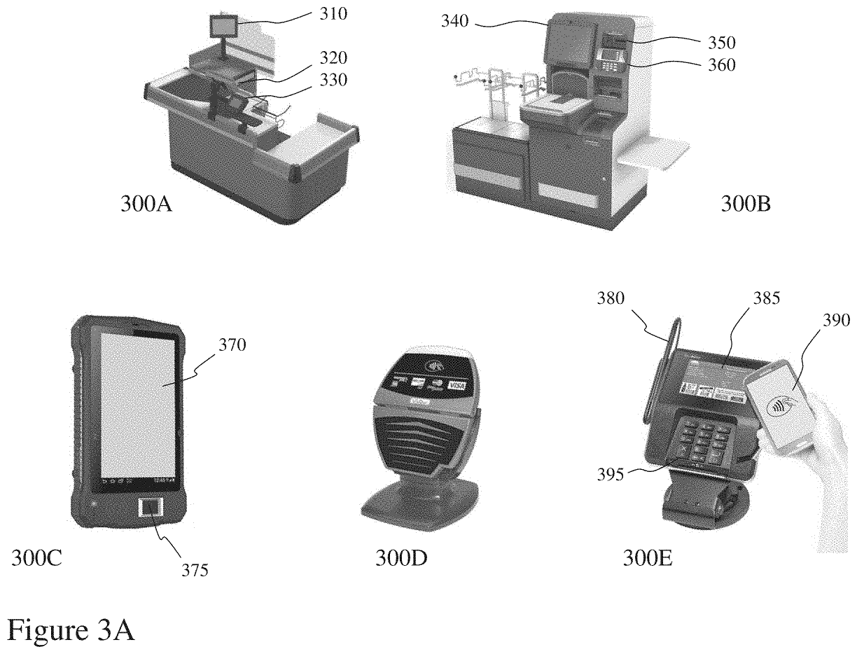

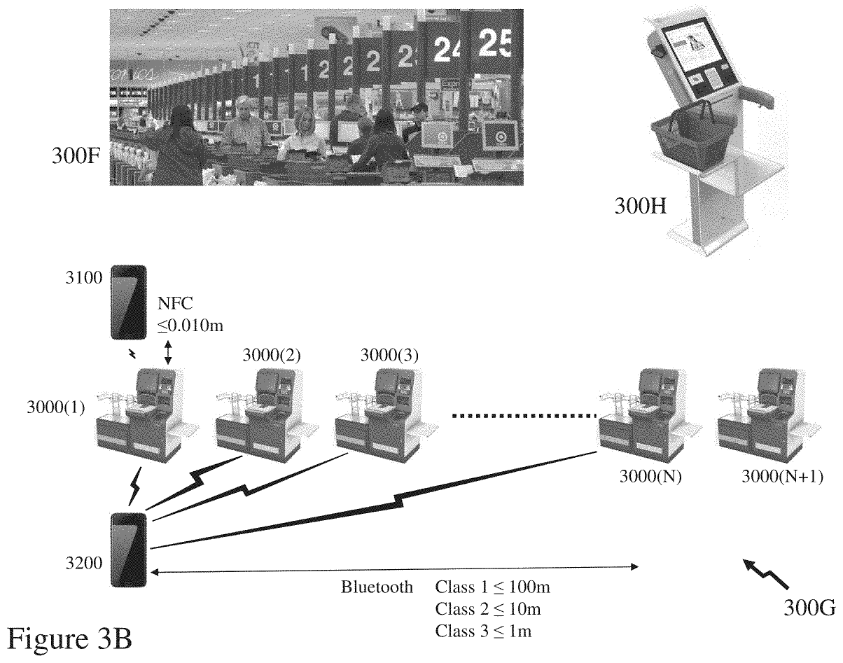

Now referring to FIG. 3A depicts examples of retail checkouts and NFC enabled Point-of-Sale (POS) terminals as currently deployed within retail environments. Accordingly, there is depicted a first checkout 300A as may be employed in retail environments where a cashier executes operations such as scanning, bagging, etc. Accordingly, the first checkout 300A comprises a display 310, for presenting information relating to the POS transaction such as indicating each scanned item, the total due, etc. The first checkout 300A further comprises a cashier interface 320 allowing the cashier to enter information or trigger actions etc. and customer interface 330 allowing the user to perform the financial transaction through known prior art methods such as swiping the magnetic stripe on a debit/credit card, inserting a debit/credit card to read data from the card, entering a personal identification number (PIN), accept or deny approval of the transaction, etc. Customer interface 330 including an NFC interface for reading a contactless debit/credit card or interfacing with an NFC interface on a PED. In contrast second checkout 300B is intended to provide a self-serve checkout such that the user scans barcodes on products and puts then into a bag or into storage area to the left-hand side with space to place a shopping basket on the right-hand side. The second checkout 300B similarly comprising a display 340, customer interface 360, and cash input interface 350 wherein a user can enter banknotes or coins.

Also depicted in FIG. 3A are first to third POS terminals 300C to 300E respectively. First POS terminal 300C being a portable POS terminal or mobile POS (mPOS) terminal as may be employed by a server within a restaurant allowing the server to accept customer payments anywhere within a retail environment rather than at fixed locations. Second POS terminal 300D represents a dedicated NFC interface as may be employed at a checkout within a retail environment. Third POS terminal 300E represents a POS terminal allowing a user to provide multiple forms of financial instrument including a swiping a credit card and/or debit card, employing a contactless credit card and/or debit card, or employing an NFC enabled smartphone 390 or another PED. The third POS terminal 300E includes a touch sensitive display 385 to provide information to a user such as amount due or approval/denial of financial instrument for example as well as a keypad 395 for the user to manually enter a PIN, for example, and a stylus 380 allowing the user to enter data via the touch sensitive display 385 rather than with their finger.

Referring to FIG. 3B there is depicted an exemplary retail environment 300G with an array of POS terminals, such as first checkout 300A or second checkout 300B in FIG. 3A. However, within a retail environment different configurations of checkouts, such as linear array, two-dimensional (2D) array, all cashier based checkouts, all self-serve checkouts, both cashier based and self-serve checkouts etc. may be employed. Accordingly, as depicted in schematic 300G whilst an NFC enabled smartphone 3100 may communicate only with a single POS terminal once brought into proximity with the NFC interface of the POS terminal, i.e. within a distance <0.01 m (≤10 cm or ≤4 inches) it is evident that a Bluetooth enabled smartphone 3200 may interact with multiple terminals according to their spacing and the class of transmitter. Accordingly, if we consider the user is positioned in a linear array of terminals 3000(1) to 3000(N+1) spaced at 2.5 metres (approximately 8 feet) then a class 2 transmitter in principle has a range of ≤10 metres (approximately 33 feet) implying that their Bluetooth enabled smartphone 3200 can cover approximately 9 terminals in a straight line. If terminals were stacked, then could be potentially more depending upon the layout of the POS terminals or alternatively if smaller self-serve checkouts such as third checkout 300H were arrayed. However, considering users in queues for each POS terminal with users without trolleys and hence spaced approximately 1 metre (approximately 3 feet) apart the number of potential Bluetooth smartphones 3200 identifiable by a POS terminal in these queues would be approximately 50 users and if there are people milling around potentially more the other side past the checkouts. As POS terminals such as first to third checkouts 300A, 300B and 300H are FEDs these may incorporate class I transmitters with substantially larger range than class 2 thereby increasing even further the number of checkouts visible to a user's PED or PEDs visible to a POS terminal.

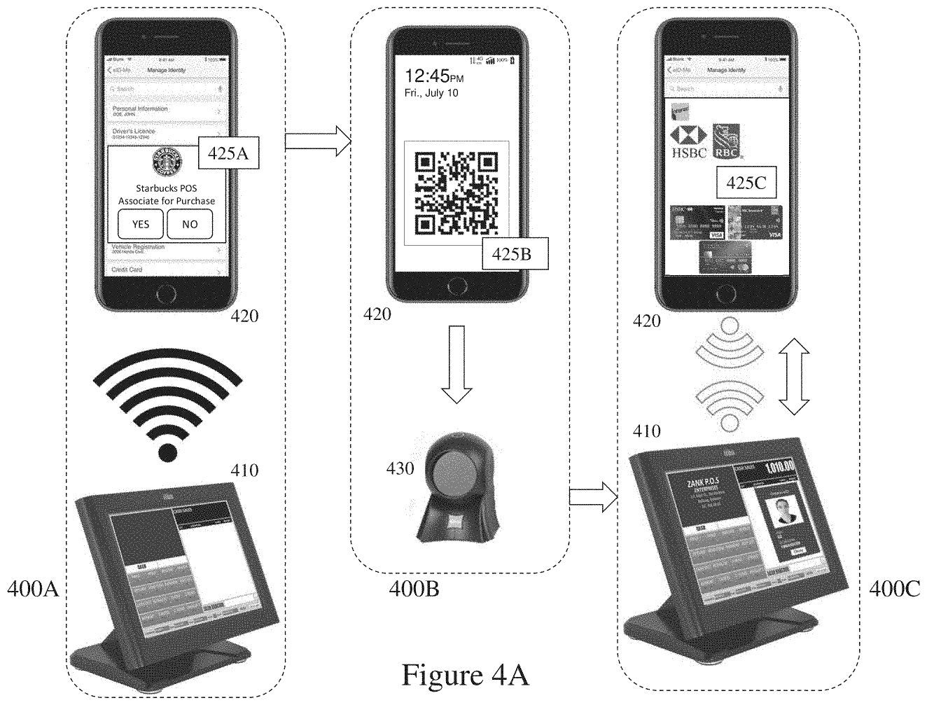

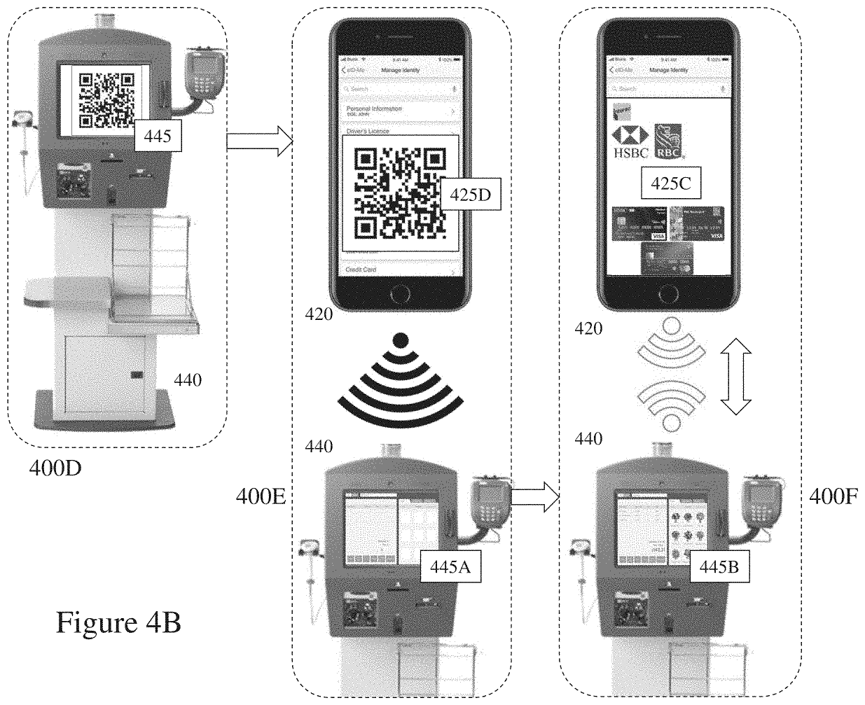

Now referring to FIG. 4A there is depicted schematically an exemplary sequence for associating a PED and POS terminal via a short-range wireless protocol according to an embodiment of the invention. As depicted the exemplary sequence occurs in first to third steps 400A to 400C. These comprising:
First step 400A, wherein a user with a PED 420 approaches within range of a POS terminal 410 which is transmitting a request to associate triggering a first pop-up window 425A wherein the user can accept or reject the connection request;
Second step 400B, wherein accepting the connection request generates a second pop-up window 425B upon the PED 420 containing a QR code which is then presented to and captured by a camera 430 associated with the POS Terminal 410 (not shown in second step 400B for clarity); and
Third step 400C, wherein communications are established between the POS Terminal 410 and the PED 420, e.g. Bluetooth association of the PED 420 as a slave to the master POS Terminal 410 or the reverse, thereby allowing the user to authorise payment in respect of the POS transaction being performed.

Optionally, the POS Terminal 410 may provide an electronic receipt directly to the PED 420 or it may alternatively print a physical receipt as per techniques known in the prior art or electronically mail the receipt. Optionally, the user's preference (e.g. physical receipt, electronic receipt on their PED, or emailed receipt) may be encoded within the QR code presented within the pop-up window 425B. Equally, the user's email address may be encoded if that option is preferred thereby removing the requirement for the user to provide this information thereby shortening the overall POS transaction. It would be evident that in addition to the mechanics of a POS transaction that the wireless communication link between POS Terminal 410 and PED 420 may be exploited to request additional information from the user such as their postcode (zip code) as often requested for a retailer to assess where their customers come from or to provide the user with a link to a questionnaire or other information request that can be completed subsequently with the PED 420 transmitting the completed questionnaire etc. via a conventional electronic communication via a wireless interface independent of the actual POS transaction. Equally, a customer can elect to complete a questionnaire in respect of their visit and be entered into a competition to win a prize where the required codes for entering the draw are automatically extracted from the electronic receipt by an application which itself may be triggered to download as a result of the user electing to complete the questionnaire etc.

Now referring to FIG. 4B there is depicted schematically an exemplary sequence for associating a PED and POS terminal via a short-range wireless protocol according to an embodiment of the invention. As depicted the exemplary sequence occurs in first to third steps 400D to 400F. These comprising:
First step 400D, wherein a user with a PED 420 approaches a POS terminal 440 which is displaying a barcode which has displayed upon it a QR code;
Second step 400E, wherein the user with their PED 420 captures an image of the QR code 425D wherein the user's PED 420 establishes communications between the POS Terminal 440 and the PED 420, e.g. Bluetooth association of the PED 420 as a master to the slave POS Terminal 440 or the reverse;
Third step 400F wherein the user can select a financial instrument from their electronic wallet 425C thereby allowing the user to authorise payment in respect of the POS transaction 445B being performed upon the POS Terminal 440.

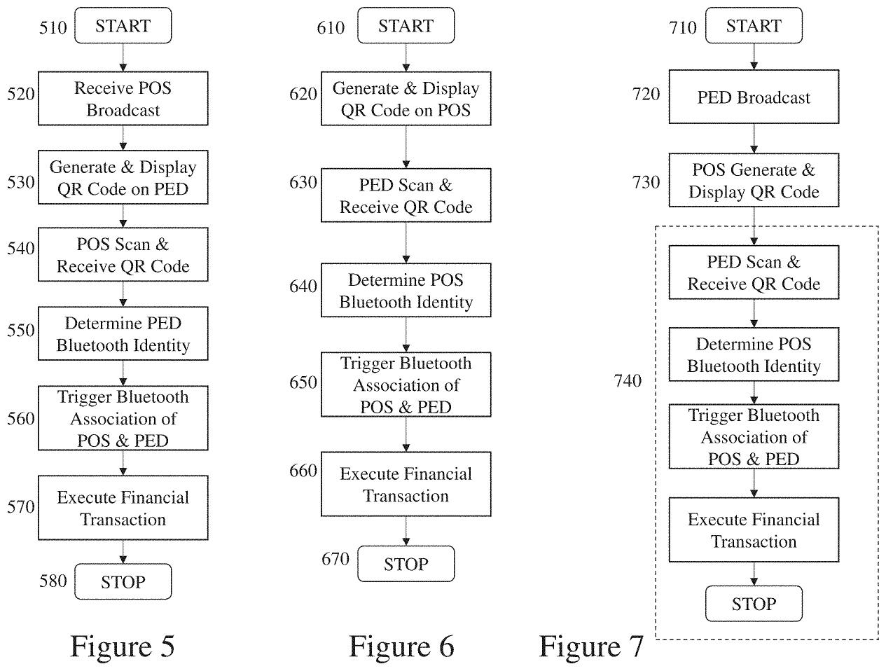

Accordingly, once the PO transaction 445B has been completed the POS Terminal 440 can generate new QR code 445 for display which allows another user to now capture, establish communications and perform another POS transaction. The displayed QR code 445 may include the electronic identity of the POS Terminal for the ad-hoc association of the POS Terminal with the PED 420. It would be evident that the association may be preferential for the PED to act as master preventing another device associating with the POS Terminal during the POS transaction and provisioning of financial credential details. Whilst the embodiments of the invention in respect of FIGS. 4A and 4B together with those in FIGS. 5 to 11 are primarily described and depicted with respect to the use of Bluetooth as the short-range wireless protocol it would be evident that the embodiments of the invention may exploit any short-range wireless protocol that the user's device, e.g. their PED, and a POS Terminal have in common. However, it would be evident that within other embodiments of the invention the POS Terminal and PED may exploit the establishment mechanisms described and depicted but that the wireless protocol may be a medium-range wireless, a long range wireless protocol, or other wireless protocol that allows the user's PED and the POS Terminal to communicate

It would be evident that a variant of the processes described and depicted in respect of FIGS. 4A and 4B may comprise capturing a QR code from a POST as the trigger for generating a QR code upon the user's PED which is then captured upon the POST. Alternatively, a QR code displayed upon the user's PED is captured by the camera of the POST thereby triggering the POST to display a QR code which is then captured by the PED.

Optionally, the barcode may be a linear (one-dimensional, 1D) barcode read with a scanner of the POST or captured with a camera of the PED.

Optionally, the barcode may be a 1D barcode read with a scanner of the POST to trigger an event which results in the PED replacing that 1D barcode with another 1D barcode. This process may repeat several times. Similarly, the POST recognizing that it has acquired a QR code triggers an event resulting in the PED displaying another QR code. For example, an initial QR code may be employed defining an identity associated with a wireless transceiver of the PED or POST whilst subsequent QR codes may relate to encryption, personal identifiable information (PII), transaction receipt, transaction authorisation, type of financial instrument to be employed in the financial transaction (so the POST can configure), etc.

Now referring to FIGS. 5 to 8 there are depicted exemplary process flows for associating a PED and POS terminal via a short-range wireless protocol according to an embodiment of the invention. Referring to FIG. 5 there is depicted a process according to an embodiment of the invention such as depicted in FIG. 4A comprising first to eighth steps 510 to 580 respectively, these steps comprising:
First step 510 wherein the process is initiated by the POS Terminal (POST) broadcasting an association request;
Second step 520 wherein the PED receives the POST association request;
Third step 530 wherein the PED generates and displays a QR code upon its display;
Fourth step 540 wherein the POST scans and receives the QR code;
Fifth step 550 wherein the POST determines the PED Bluetooth identity from the QR code;
Sixth step 560 wherein the POST triggers the association of the PED and POST;
Seventh step 570 wherein the POST and PED execute the financial transaction; and
Eighth step 580 wherein the association of the POST and PED is terminated, and the process stops.

Referring to FIG. 6 there is depicted an exemplary process flow for associating a PED and POS terminal via a short-range wireless protocol according to an embodiment of the invention such as depicted in FIG. 4B comprising first to seventh steps 610 to 670 respectively, these steps comprising:
First step 610 wherein the process is initiated by the POS Terminal (POST);
Second step 620 wherein the POST generates and displays a QR code on the POS;
Third step 630 wherein the PED scans and receives the QR code displayed upon the POST display;
Fourth step 640 wherein the PED determines the POST Bluetooth identity from the QR code;
Fifth step 650 wherein the PED triggers the association of the PED and POST;
Sixth step 660 wherein the POST and PED execute the financial transaction; and
Seventh step 670 wherein the association of the POST and PED is terminated, and the process stops.

Now referring to FIG. 7 there is depicted an exemplary process flow for associating a PED and POS terminal via a short-range wireless protocol according to an embodiment of the invention comprising first to third steps 710 to 730 respectively and process block 740, these steps comprising:
First step 710 wherein the process is initiated by the PED user;
Second step 720 wherein the PED broadcasts an association request;
Third step 730 wherein the POST generates and displays a QR code on the POS in dependence upon identifying the PED association request;
Process block 740 which comprises steps equivalent to third through seventh 630 to 670 respectively in FIG. 6 and terminates.

FIGS. 4A to 7 depict embodiments of the invention relating to displaying, receiving and acquiring decrypting electronic content by a user wherein a code, e.g. a Quick Response (QR) code, is captured by an application as part of the scanning acquisition of the information necessary to associate one electronic device, typically a PED, to another electronic device, typically a FED such as POS Terminal. Optionally, the QR code may exploit ciphertext in order to obtain data identifying a private encryption key that should be used during the subsequent communication session or to decrypt an appropriate symmetric key for use in decrypting/encrypting within the communications session. Optionally, the QR code could also be used to identify which encryption/decryption standard is used for securing the ciphertext or electronic file. Alternatively, the QR code could itself also be in an encrypted format that can only be unlocked by the user's private key. Optionally, the QR code itself could contain hypertext relating which needs to be decrypted by the application before any of the processes can be performed as the hypertext relates to a hyperlink identifying a Uniform Resource Locator (URL) relating to the location of the encrypted text or file on the Internet, private network, etc.

Within the subsequent descriptions of embodiments of the invention terms such as scanning, performing a scan, a scan, etc. refer to a sequence of operations wherein content is captured using a first process, e.g. optically scanning or optically imaging the content to generate an optical image or images, and a second process, e.g. optical character recognition, to convert the image to cipher text. Accordingly, some steps may have been and may be omitted within descriptions relating to codes in order to keep process descriptions focused to the steps relating to embodiments of the invention, but such omitted steps would be evident to one of skill in the art.

Accordingly, referring to FIG. 8 there is depicted a process comprising the steps of:
Step 810—Start process;
Step 820—Receive and scan QR code;
Step 830—Determine private encryption key in dependence upon the QR code;
Step 840—Receive encrypted content;
Step 850—Decrypt the received encrypted content using the selected private encryption key; and
Step 860—Stop process.

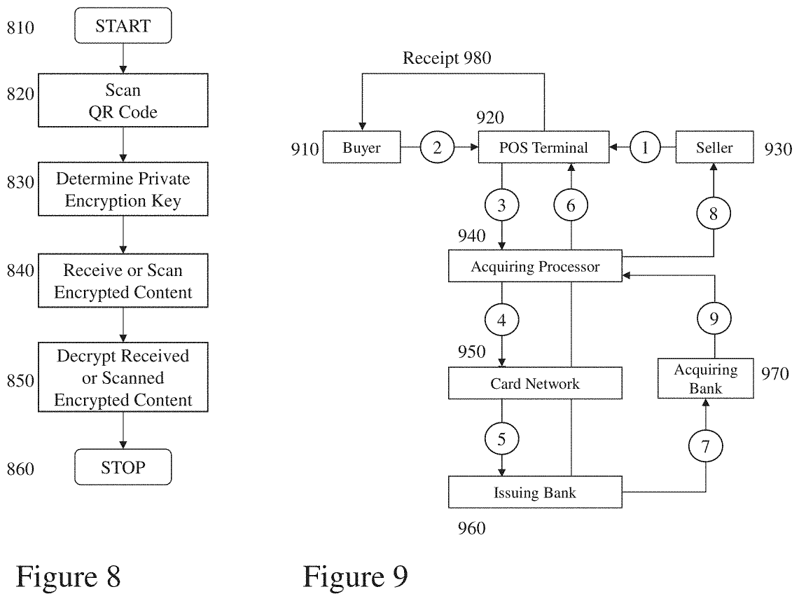

Accordingly, the process flow in FIG. 8 may be integrated within the process flows depicted in FIGS. 5 to 7. Equally the process flows of FIGS. 5 to 7 with or without modifications such as depicted in FIG. 8 may be employed in an overall financial process such as depicted in FIG. 9 for a financial process exploiting embodiments of the invention wherein a Buyer 910, POS Terminal (POST) 920, and Seller 930 engage in a financial transaction that then includes an Acquiring Processor 940, Card Network 950, Issuing Process or Bank 960, and Acquiring Bank 970. Accordingly, the card transaction process flow comprises steps:
Step 1 wherein the Seller 930 enters the purchasing details;
Step 2 wherein the Buyer 910 authorises a financial transaction relating to the financial details;
Step 3 wherein the POST 920 communicates with the Acquiring Processor 940 (or alternatively does so via a Payment Terminal (not shown for clarity));
Step 4 where the Acquiring Processor 940 routes information to the appropriate Card Network 950, e.g. Visa™, Mastercard™ etc.;
Step 5 where the information is then routed to the Issuing Bank 960 which either authorises or declines the transaction on the buyer's financial instrument;
Step 6 where the result is routed back to the POST 920;
Step 7 where upon authorisation the Issuing Bank triggers a disbursement of funds to the Acquiring Bank through the Card Network for the transaction amount;
Step 8 wherein the Acquiring Processor 940 then transfers the money to the Seller's bank account (adjusted for any service charges); and
Step 9 wherein the funds are then settled from the Acquiring Bank to the Acquiring Processor, typically within 1-2 business days.

Upon confirmation of the financial transaction the process provides the Buyer 910 with a Receipt 980. As noted supra this receipt may be delivered via the active wireless communication session between the user's PED and the POST but it may alternatively be electronically delivered to a different address.

It would be evident that the POS transaction may trigger one or more other electronic actions by the seller (retailer) or by an enterprise associated with a product and/or service in that the POS transaction may initiate communications from the seller to the enterprise associated with a product and/or service in addition to the communication with the buyer.

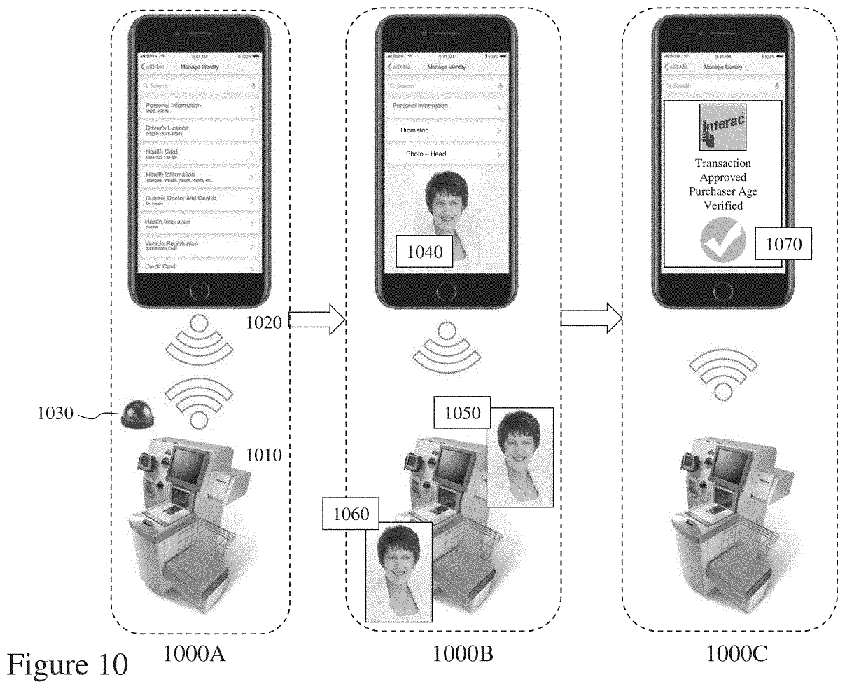

Within some POS transactions the user may be seeking to purchase an age restricted product, such as alcohol, tobacco etc. Whilst a POS Terminal with a physical checkout person provides for an ability to request and check an identity that it would be beneficial for the age-related checking to be automated to remove opportunities for bypassing it within a staffed checkout but also within self-service (self-serve) checkouts where the user performs the scanning processes together with bagging/packing as appropriate. FIG. 10 depicts an exemplary sequence for performing an age verified transaction at a self-service POS terminal according to an embodiment of the invention as depicted in first to third steps 1000A to 1000C respectively.
First step 1000A wherein a POS Terminal (POST) 1010 and PED 1020 are in communication as a result of a process such as described supra in respect of FIG. 4A to FIG. 8 wherein the POST 1010 now incorporates a camera 1030;
Second step 1000B wherein the POST 1010 determines that an age-related product has been scanned and requires age verification prior to continuing wherein the POST 1010 captures an image of the user 1060 with the camera 1030 and requests the user to provide a verified photograph 1040 which is transmitted from the user's PED 1020 to the POST 1010 as electronic verified image 1050; and
Third step 1000C wherein the POST 1010 performs image matching of the electronic verified image 1050 and the POST 1010 acquired image 1060 to determine whether the user is that making the purchase wherein a successful match triggers a transaction approval 1070 from the POST 1010 to the PED 1020.

Optionally, the self-service POST may be associated with a retail environment that only sells age restricted products wherein the age verification process may be required prior to any scanning. Equally, the process may be employed in a staffed POST allowing the process to be independent of the staff and any issues over user's presenting identity etc. Upon a failed transaction the POST may perform one or more actions including, but not limited to, cancelling any existing transaction, triggering an audible alarm, triggering a visual alarm, and alerting staff.

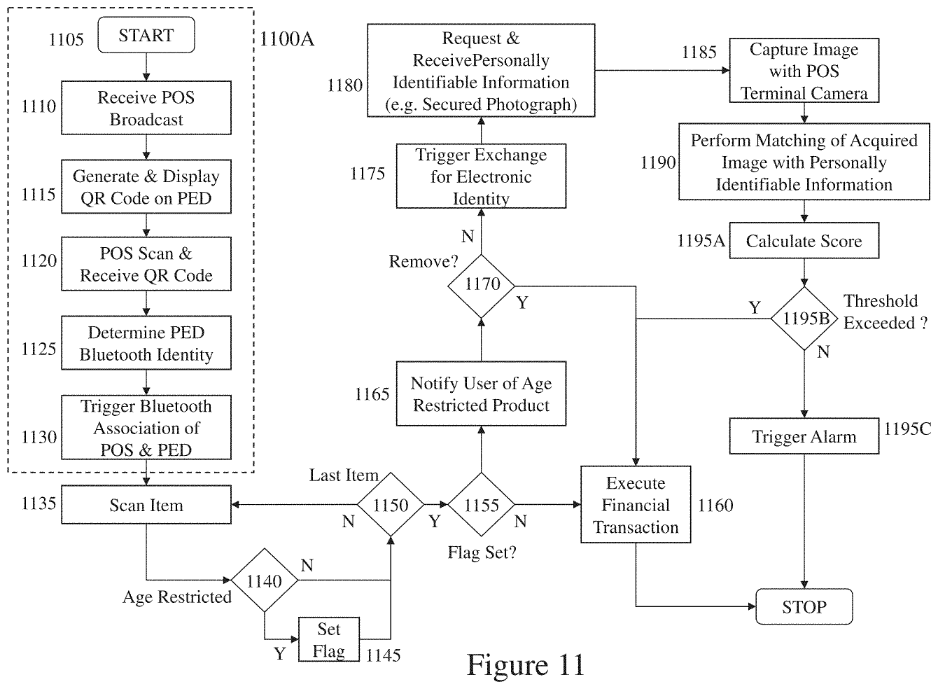

Now referring to FIG. 11 there is depicted an exemplary process flow for associating a PED and a self-service POS terminal via a short-range wireless protocol and performing an age verified transaction at the self-service POS terminal according to an embodiment of the invention. As depicted the process begins with steps 1105 to 1130 within sub-flow 1100A which are comparable to the steps 510 to 560 within the exemplary process flow depicted in FIG. 5.

Upon completion of sub-flow 1100A the process proceeds to step 1135 wherein an item is scanned and then in step 1140 a determination is made as to whether the scanned item is age restricted. If not, the process proceeds to step 1150 but if it is age restricted the process proceeds to step 1145 to set a flag, and then proceeds to step 1150. In step 1150 the process determines whether the item scanned is the last or not and either returns to step 1135 or proceeds to step 1155. In step 1155 a determination is made as to whether the flag relating to an age-related product was set during the scanning process. If not, the process proceeds to step 1160 wherein a financial transaction is executed, and the process stops. If, however, the flag was set the process proceeds to step 1165 and notifies the user that an age restricted product is within the transaction.

In step 1170 a determination is made as to whether the age-related product(s) have been removed from the transaction or not. If so the process proceeds to step 1160 otherwise it proceeds to step 1175 wherein the exchange of electronic identity information is triggered and the POST requests and receives in step 1180 Personally Identifiable Information (PII), e.g. a secured photograph. Subsequently, in step 1185 the POST captures an image with a POS Terminal camera which is subsequently employed with the PII in step 1190 to perform matching of the acquired image wherein subsequently in step 1195A a score is calculated which is then compared with a threshold in step 1195B. If the threshold is exceeded, then the process proceeds to step 1160 and the financial transaction is performed. If the threshold is not exceeded, then an alarm is triggered in step 1195C and the process ends.

Optionally, a POST may be triggered to display a QR code based upon an event such as scanning a first product after completing a previous financial transaction, executing a predetermined process upon the POST such as totaling a sale, scanning a predetermined barcode by the user or a cashier, etc.

Within embodiments of the invention the provisioning of information from a PED, for example, to a POS Terminal, for example, involves the provisioning of personally identifiably information (PII) which may include one or more of the following data types including but not limited to user name, credit card number, credit card type, credit card provider, debit card number, debit card type, debit card provider, PED identity, and biometric information. Such information may be released in some embodiments of the invention automatically or based upon a user authentication/authorisation process executed upon their portable device, e.g. PED. Such authorisation/authentication process may include one or more security verifications such as user entry of a personal identification number (PIN), password, security code, user information etc. or acquisition of biometric information. Exemplary points at which the release of PII may be subject to authorisation by the user include as depicted in FIGS. 4 to 9 respectively include but are not limited to:
First step 400A in FIG. 4A relating to transmitting a request to associate a PED with a POST thereby triggering a first pop-up window 425A wherein the user can accept or reject the connection request;
Third step 400C in FIG. 4A relating to allowing the user to authorise payment in respect of the POS transaction being performed;
Second step 400E in FIG. 4B wherein a user establishes communications between the POS Terminal 440 and the PED 420
Third step 400F in FIG. 4B allowing the user to authorise payment in respect of the POS transaction being performed
Third step 530 in FIG. 5 relating to the PED generating and displaying a QR code upon its display;
Third step 630 wherein the PED scans and receives the QR code displayed upon the POST display;
Fifth step 650 wherein the PED triggers the association of the PED and POST;
First step 710 wherein the process is initiated by the PED user:
FIG. 8 relating to either scanning a QR and/or decrypting content within a QR code; and
Step 2 in FIG. 9 wherein Buyer 910 authorises a financial transaction relating to the financial details.

Asset Management

The association of a POST and a PED in order to perform a financial transaction represents one example of a user accessing with their PED an asset (in this instance the POST) in order to perform an action or activity with respect to the asset when a plurality of assets are accessible to the PED wirelessly but only one specific asset is sought within this plurality. As outlined with respect to the embodiments of the invention above asset—device pairing is established based upon the presentation and acquisition of visual codes. However, within the wider applications of asset management there exists the requirement for the secure sharing of assets through an electronic means. Within the context of asset management an asset may, for example, be an electronic file, an item of electronic content, an automobile, a lock, and an electronic device. Essentially, an asset is anything can be defined as having an owner and a means to protect it. For example, the protection mechanism could be in the form of an encryption key, for an electronic file or electronic content wherein the electronic content and/or electronic file is encrypted until it is accessed through a decryption with the appropriate key. Alternatively, the device upon which the electronic content and/or electronic file are to be accessed and/or rendered is locked until the appropriate security credential(s) are presented. A security credential is one form of “secret” which provides access to the locked asset. For example, the secret may unlock an electronic door lock or allow a user to access an automobile.

Within embodiments of the invention for secure asset sharing an asset owner authorizes access to the asset for other users within an electronic identity transaction, referred to within this specification as an Electronically Identify Me (eID-Me) transaction. An eID-Me transaction is typically performed through a web service which maintains a community of registered user (eID-Me users) and assets. A users may, for example, browse one or more webpages, websites, databases, electronic content repositories etc. through the web service and upon identifying an asset they wish to access execute a process of requesting access to the asset from an owner of the asset. This triggers an eID-Me identity transaction which contacts the asset owner for approval. Reference to eID-Me within this specification is intended to refer to a process of “electronically identifying an individual” and is not intended to be limited to the software application “eID-Me” provided by BluInk Ltd. of Ottawa, Ontario, Canada (www.buInk.ca/eid-me).

Access to the requested asset may be immediate within some embodiments of the invention. For example, if the asset is an encrypted file then a decryption operation can be triggered immediately upon the asset owner approving access to the asset.

Alternatively, the access to the asset may be deferred. For example, a user is booking a car for a requested booking period, the owner may approve the booking, but the actual operation of unlocking the car only happens later when the user approaches the car during the requested booking period. This may include a second eID-Me transaction where the car validates the user's identity through, for example, issuing a challenge to the user's PED wherein PED responds with the secret to unlock the car.

Accordingly, an objective of embodiments of the invention is to define a common secure asset sharing web services framework that can be used in many different applications supporting a number of asset sharing use cases. Whilst the embodiments of the invention will be described with respect to a management protocol established by the users it would be evident that other management protocols meeting the requirements outlined with respect to the design objectives for the secure asset sharing web service may be employed without departing from the scope of the invention. The framework established by the inventors being referred to as eID-Me Federated Key Management, Federated Key Management (eID-Me FKM) according to embodiments of the invention being described below. eID-Me FKM enables the secure sharing of assets and can be easily incorporated into a wide range of applications, including but not limited to those described below.

Examples of secure asset sharing scenarios supported by eID-Me FKM include, but are not limited to, secure file sharing, allowing features such as user management, folder sharing, adding a user to a folder, removing a user from a folder, encrypt on upload to a secure folder, encrypt on upload to plain folder, decrypt on download for eID-Me user, decrypt on download for non-eID-Me user; securing medical record sharing, secure car sharing etc.

SECURE FILE SHARING: A file browser, such as File Browser (https: filebrowser.github.io), provides users with an interface for uploading and downloading files from a cloud-based server.

User Management: Secure file sharing can support eID-Me users and non-eID-Me users. In the latter case, users register on the site with a username and password. When an eID-Me user signs up to the Secure File Sharing website (site), they receive a request on an electronic identity management application (eID-Me Application or eID-Me App) to generate a key pair for use with the site. This key pair enables encryption and decryption of files targeted for the user and consists of a public key and a private key. The public key is transferred to site and stored with an association to the user.

Within this specification exemplary code segments and commands are outlined with respect to “eID-Me” an online and face-face services software application provided by BluInk Ltd. of Ottawa, Ontario, Canada (www.bluink.ca/eid-me). For example, in respect of the key generation and transfer an exemplary request may be structured as follows within the software application coding:
Claim: asymmetric_public_key
Claim: given_name
Op: export_public_key
Algo: RSA2048
KeyId: “file_sharing_key”

Accordingly, this process exploits an algorithm “RSA2048” which employs the RSA (Rivest-Shamir-Adleman) asymmetric cryptosystem with 2048 bits wherein the encryption key is public and it is different from the decryption key which is kept secret (private).

Folder Sharing: A user can mark an entire folder for secure file sharing. When this is done, an Advanced Encryption Standard (AES) key is randomly generated, encrypted with the user's public key, and associated with the folder. An asset security object is created to store this association and wrapped key. Once this is completed all files added to this folder will be automatically encrypted using the folder key.

Exploiting a one key per secure folder methodology avoids multiple authorizations which would need to occur if each file had its own AES key. However, within other embodiments of the invention each file may be encrypted with its own AES key.

Add User to Folder: Through a user action, for example a right-click menu option, the folder “owner” can add an individual for automatic sharing of files within the target folder. This is convenient when a team of users need to securely access a group of files. Selected users would therefore be eID-Me users who are already registered on the system. This operation triggers a private key operation on the owner's eID-Me software application (e.g. a smartphone application) to decrypt the folder key, so that it can be re-encrypted with the other user's public key and stored within an asset security object.

Remove User from Folder Through a right-click menu option the folder “owner” can remove an individual from being able to access files within the target folder. This operation is accomplished by deleting the associated asset security object for the <user, folder> pair.

Encrypt on Upload to Secure Folder When an eID-Me user uploads a file to a a secure folder the file will be automatically encrypted and stored on the hosting server. The encryption will use the AES key associated with that secure folder (this requires an authorization from the uploading user). Note that any user who has an asset security object for this folder can perform an upload to secure folder.

Encrypt on Upload to Plain Folder When an eID-Me user (User A) uploads a file to a plain folder, the file will be automatically encrypted using a randomly generated AES key, for example a 256 bit key, and stored on the hosting server. No authorization is required to do this. The randomly generated AES key is then be encrypted with User A's public key and stored as an asset security object. At this point the uploaded file is secured and can only be decrypted by a key operation using User A's private key, such as accessed by User A through their eID-Me smartphone application, for example.

Decrypt on Download for e/D-Me User When a registered eID-Me user requests a download of a file, and there is an asset security object for the file and requesting user, then the user is contacted, for example via their eID-Me smartphone application, in order to perform a decryption operation.

Decrypt on Download for non-eID-Me User If a non-eID-Me user requests a download of a file, then the asset owner is contacted, for example via their eID-Me smartphone application, in order to perform a decryption operation. In this operation the asset owner is provided additional information during the transaction, informing them of the identity of the requesting user seeking access and which file, files, folder or folders the requesting user is seeking access to. For example, in respect of this an exemplary request may be structured as follows within the software application coding:

| | | |
|---|---|---|
| Claim | 1.3.6.1.4.1.50715.5.1 | (asymmetric_public_key) |
| Op | unwrap | |
| KeyId | “file_sharing_key” | |
| Payload | <the wrapped file AES key> | |

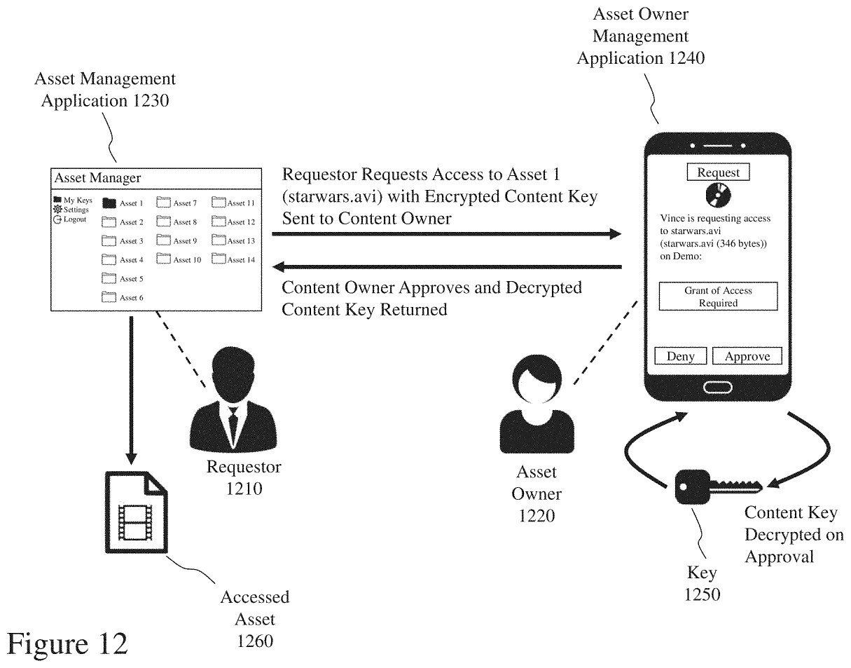

This process is depicted schematically in FIG. 12 wherein a Requestor 1210 requires permission from a Content Owner 1220 to access an asset within an Asset Management Application 1230. Accordingly, the Requestor 1210 selects, for example Asset 1, wherein the Asset Management Application 1230 sends a request to the Content Owner 1220 comprising request details, such as asset to which access is being sought and identity of Requester 1210, and the encrypted content key are sent to the Content Owner 1220, for example as indicated upon their smartphone running an Asset Owner Management Application 1240. The Content Owner 1220 is then presented upon accessing the request with the request details and an indication that they are required to grant access together with “Approve” (or equivalent for granting access) and “Deny” (or equivalent for not granting access). If the Content Owner 1220 selects “Approve” the Asset Owner Management Application 1240 decrypts the encrypted content key to generate Key 250. The approval from the Content Owner 1220 together with the Key 1250 are then transmitted back to the Asset Management Application 1230 wherein the requested asset, Asset 1, is unlocked as Accessed Asset 1260.

It would be apparent to one of skill in the art that the granting of access to an asset may within embodiments of the invention be, for example:
Permanent allowing subsequent access at any point by the requesting user;
Temporary allowing access for a limited time period by the requesting user;
Temporary allowing one-time access by the requesting user, and
Temporary allowing access for a limited number of accesses by the requesting user.

Optionally, within other embodiments of the invention the access grant may result in the asset being converted to a non-editable format but allowing the requesting user to view the asset. For example, a content owner may be maintaining a word processing document but in order to provide access to others without granting an ability to edit or amend the document then the access granting process may result in the access rights of the requesting user being changed to read only or alternatively the document is automatically converted to format such as a Portable Document Format (PDF). Optionally, the granting of access may result in the requesting user being provided through the same channel as the request management process or a different channel with a secret required to access the asset. In this manner, the asset is securely stored in a decrypted form but once access is granted and the asset is accessible in unencrypted form by the requesting user they must still provide the secret to access the asset.

It would be evident that within other embodiments of the invention the secret may be provided by the content owner or it may be automatically generated by the asset owner management application. Whilst within FIG. 12 the scenario is depicted as comprising Asset Management Application 1230 and Asset Owner Management Application 1240 it would be evident that these may be same application. In this instance the application automatically tracks the content owner, e.g. the originator of the asset within the application so that the relevant association of content owner and assets is maintained within a database. Accordingly, the application may exploit a cloud based server to maintain the database as well as other records such as user registrations, user electronic addresses, etc.

SECURE SHARING OF MEDICAL RECORDS: It would be evident that the exemplary embodiment of the invention described and depicted above with respect to secure file sharing may be applied to applications such as the secure sharing of medical records. In this instance, rather than a general Asset Management Application 1230 and/or Asset Owner Management Application 1240 the secure medical record sharing may be hosted through a web service such that a doctor, for example, can maintain their patients' medical records in a secure manner (as they are encrypted) upon a cloud based server and then subsequently another medical practitioner (medical facility) registered with the web service may request access to a specific patient's medical records wherein access may, for example, require that both or one of the patient's doctor and the patient themselves authorise access. Allowing either the patient's doctor or the patient to authorise release allows for access to be granted to one or more other medical practitioner's or medical facilities in emergencies such that as when the patient's doctor is unaccessible or the patient is unable to provide authorisation themselves. In this instance the asset management application(s) may be configured to send any request for access automatically to both the patient's doctor and the patient such that the scenarios of either one of or both being required to provide approval for access can be managed within the software application(s).

It would be evident that within such instances, medical records generated by a different medical practitioner and/or medical facility may be subject to a subsidiary process wherein the patient's doctor can request that the records for their patient are either duplicated to their patient's medical records such that they are then under the same asset ownership allowing subsequent access by a third medical practitioner and/or medical facility based upon approval of the patient's doctor and/or the patient rather than the medical practitioner and/or medical facility generating them being required to authorise subsequent access requests such that over time a single authorisation and provide access to the patient's entire medical history rather than requiring every medical practitioner and/or medical facility to authorise their specific portions. Where the records are duplicated this may be the entire record of the other medical practitioner and/or medical facility or a predetermined portion thereof. In the latter instance the medical practitioner and/or medical facility can subsequently decide whether to grant access to another third party in the event of a request, e.g. to their medical insurer in the event of a claim by the patient. Accordingly, in this latter scenario the full medical records of the medical practitioner and/or medical facility are themselves stored securely separate to the patient's record.

SECURE VEHICLE SHARING Within the following description the application of embodiments of the invention to a Secure Vehicle Sharing service are described and depicted. For example, such as Secure Vehicle Sharing service may exploit an operating system aimed at embedded systems market(s) such as the Unix-like QNX microkernel based OS (https://blackberry.qnx.com/en) or Microsoft Auto for example. In this embodiment of the invention the system generally comprises two components:
a Secure Vehicle Sharing website; and
a Secure Vehicle Sharing application (e.g. a QNX application) which runs on the automobile).

The Vehicle Sharing website within the following description is described as exploiting eID-Me, an online and face-face services software application provided by BluInk Ltd. of Ottawa, Ontario, Canada (www.bluInk.ca/eid-me), however it would be evident that alternative embodiments may exploit other methodologies for establishing and validating a user's identity and managing the approval processes etc. Similarly, the Vehicle Sharing application is described and depicted as exploiting eID-Me with in-person transactions.

User Management: The Secure Vehicle Sharing system may, within embodiments of the invention, only support eID-Me users who have previously registered and been verified. Within embodiments of the invention the registration process may in addition to acquiring user personal details directly access one or more Government systems in order to extract and/or validate a user's driving license. Within another embodiment of the invention the registering user may be required to provide images of the front and back of their physical driving license with the acquisition process controlled through the Vehicle Sharing website application using a camera within a user's computer, smartphone, laptop etc. When an eID-Me user signs up to the Secure Vehicle Sharing website and service they receive a request on their eID-Me application to generate a key pair for use with the Secure Vehicle Sharing website. This key pair enables the subsequent unlocking of an automobile. The public key is returned to the Secure Vehicle Sharing website and stored with an association to the user's registration.

For example, in respect of this an exemplary request may be structured as follows within the software application coding:
Claim: asymmetric_public_key
Claim: given_name
Op: export_public_key
Algo: RSA2048
KeyId: “vehicle_sharing_key”

Create Automobile Listing: Within embodiments of the invention a user, e.g. an organization, enterprise, individual, etc. can create an automobile listing by providing the required forms of information and, optionally, uploading photographs of the automobile. The listing would typically have basic information about the automobile, such as make, colour, etc. as well as a rate for rental, location for pick-up etc. Optionally, within other embodiments of the invention the inventory of automobiles at a location may vary as the organization/enterprise offering the vehicles for rental allows a user to drop off the automobile at a different location to the one it was picked up from.

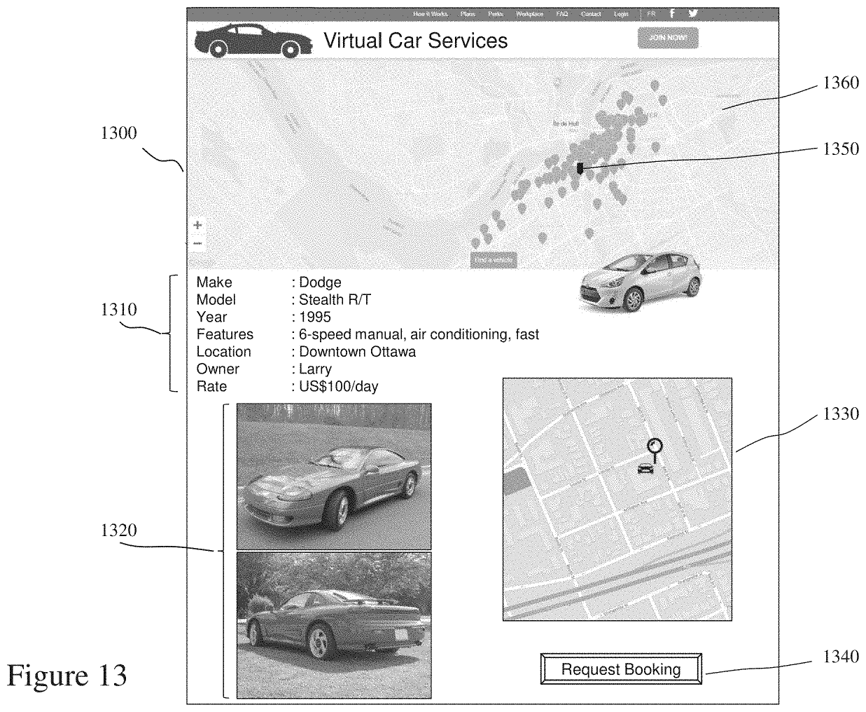

Each automobile listing will have an asset security object created for it so that the owner can authorize bookings. Optionally, the system may support multiple classes of automobiles; such as user-owned or fleet-owned for example. Typically, a different Vehicle Sharing Website will be associated with each organization/enterprise operating fleet-owned automobiles, e.g. a vehicle rental agency such as Hertz™, Avis™, etc. or a vehicle sharing—virtual vehicle service such as is owned by the vehicle sharing site. A typical listing may be depicted as shown in FIG. 13 comprising a webpage 1300 wherein the user has selected a location 1350 within the map 1360 resulting in the vehicle information 1310 and photographs 1320 being displayed together with more detailed location information in map 1330. A button 1340 allows the user to proceed and request a booking. It would be evident that other methodologies may be employed to allow a user to search for a vehicle based upon filters such as cost, make, type, location, availability against selected dates etc. without departing from the overall scope of the invention with respect to securing an asset and providing a predetermined user with access to the asset. Based upon the user selecting the button to request booking the automobile process then proceeds through to Book Automobile and Unlock Automobile with an optional additional step of Start Automobile. Other processes executed by the overall Secure Vehicle Sharing system not immediately evident to the user may include Retrieve Bookings for Automobile and Wireless Advertising.

Book Automobile: A user who browses automobile listings can request a booking by pressing a “book vehicle” button, e.g. Button 1340 in FIG. 13, associated with a listing A user would then pick a time period in which they want to book the vehicle (if this has not already been entered earlier within a search process to identify vehicles available within a time period the user desires to book access for). Optionally, the booking can be established a different granularities as defined by an individual registering their vehicle or an organization/enterprise registering a fleet of vehicles. For example, the finest granularity may be set to an hour allowing a user to book for as little as an hour or it may be two hours, four hours, eight hours, a day etc. The user can also block out periods of availability such that no bookings can be taken during these periods. For example, a user who commutes by train Monday-Friday leaving home at 7 am on average and returning at 6 pm on average can set their vehicle as being available for booking Monday-Friday 8 am-5 pm and remove specific weeks, national holidays, periods of time etc. that they will wish to ensure access to the vehicle. It would be evident that optionally an enterprise may also offer this service to families such that a family can have different members access the vehicle at defined periods with bookings etc. to remove conflicts etc. or allow another family member to access their vehicle when necessary.

Once a booking request has been initiated, the browsing user is contacted via the eID-Me application. For example, the eID-Me transaction may be executed and structured as follows within the software application coding:

| | | |
|---|---|---|
| Claim | mto_dl_number | (Driver License number) |
| Claim | mto_dl_expiry_date | (Driver License expiry date) |
| Claim | given_name | |

Accordingly, these claims may be mandatory so that the driver license identity forms part of the transaction together with the expiry date of the driver license and the user's given name. Accordingly, if these fields are not supplied by the user or alternatively have been supplied but are unverified then the Secure Vehicle Sharing system may deny the booking request automatically and the transaction stopped. Ideally, the user when registering may provide this information and the Secure Vehicle Sharing system may contact the appropriate Government licensing authority to confirm this information. For example, the Ministry of Transport Ontario (MTO) for driver licenses issued in Ontario, Canada; California Department of Motor Vehicles for driver licenses issued in California, U.S.A.; and Driving Vehicle Licensing Authority for driver licenses issued in United Kingdom.

In the next step, if the vehicle is user-owned, the vehicle owner is contacted by an eID-Me transaction which displays information to the owner including but not limited to:
The requesting user's name.
The vehicle listing reference descriptive name.
The time period for the booking.

The transaction will also request a private key operation to authorize the booking, which may be structured as follows within the software application coding:
Claim: asymmetric_private_key
Op: unwrap
Key Id: “vehicle_sharing_key”
Payload: <vehicle unlock key>

If the owner approves the booking, then the vehicle unlock key is decrypted by the owner's vehicle service private key and returned in the response. The Secure Vehicle Sharing service will then re-wrap the decrypted vehicle unlock key with the requestor's public key, and create an asset security object for the booking. Additionally, the vehicle sharing service generates a wireless pairing code, for example a Bluetooth Low-Energy (LE) pairing code for this session, store it in the booking, and display it for the user.

Retrieve Bookings for Automobile: The vehicle sharing applications running in the vehicles, e.g. those exploiting QNX, Microsoft Auto etc., periodically query the vehicle sharing service to retrieve any booking updates. Typically, only bookings that occur in the future will be returned in these queries. The query rate can be set by the owner and/or the vehicle sharing service, for example every 15 minutes, every hour, etc. Each retrieved booking contains the asset security object which includes the eID-Me user who booked the vehicle, the time period for the booking, the wrapped vehicle unlock key and the wireless pairing code.

Wireless Advertising: Whenever the vehicle sharing application sees a booking that is nearing its scheduled start time, it will connect to a device installed within the vehicle and set a pair code on the device. This device may, for example, be a eID-Me POS USB device where a POS device command is created for the purpose of establishing the pairing code. Alternatively, this device may be a wireless device connected to the vehicle sharing application. Accordingly, the pairing code allows only the booking user to connect to this vehicle during the predetermined time period of the user's booking. The booking user will be required to enter the pairing code into a pop-up screen that will appear within the Secure Vehicle Sharing software installed on their PED when their booking becomes active and the user is attempting to connect to the vehicle.

Unlock Automobile: The process of unlocking a vehicle occurs as an in-person transaction, for example an in-person eID-Me transaction. An exemplary process flow for this in-person transaction comprising the steps:
Vehicle Sharing Application enables the device installed within the vehicle, e.g. an eID-Me POS USB device, for the booking and sets the appropriate pairing code for that booking together with the advertising information targeted at the intended user (i.e. the device broadcasts information targeted for the user's PED)
Booking user approaches vehicle and selects “Use My Identity” or an equivalent option within the application on their PED, e.g. the eID-Me software application.
The user's software application starts listening for the advertising information from devices installed within vehicles in the user's vicinity, e.g. the eID-Me POS USB device, seeking the appropriate targeted advertising information.
When a close device, e.g. eID-Me POS USB device, is detected, the software application, e.g. eID-Me, connects to the device.
The user when a connection is made is then prompted to enter the pairing code which when matched by the device within the vehicle establishes a secure connection between the device within the vehicle and the user's PED, e.g. a connection with Man-In-The-Middle (MITM) attack protection)
If successfully connected, the vehicle application, e.g. a QNX application, will establish the appropriate transaction, e.g. an eID-Me in-person transaction. This transaction may be structured as follows within the software application coding:
   Claim: asymmetric_private_key
   Op: unwrap
   KeyId: “vehicle_sharing_key”
   Payload: <vehicle_unlock_key>
The vehicle application, e.g. the QNX application validates the response and if the vehicle_unlock_key is valid it will trigger unlocking of the vehicle.

Start Automobile: Within some embodiments of the invention the starting of the vehicle also occurs as a result of an in-person transaction, e.g. an in-person eID-Me transaction, driven from the vehicle's infotainment system. Accordingly, in this embodiment of the invention the vehicle sharing application displays a start icon on the vehicle's user interface after the user has unlocked the vehicle. By pressing the start icon in-person transaction would occur wherein authentication results in starting of the ignition.

SECURE ASSET SHARING OBJECTS Within embodiments of the invention, such as the exemplary use cases described and depicted above, there are a series of objects required for secure asset sharing. Accordingly, these may include but not be limited to Asset Security Objects. An asset security object contains the necessary information to allow an asset to be unlocked. Examples of these may include but not be limited to asset identifier, asset description, unlocking identity, unlock key, key identifier validity start time, validity end time, and pairing code. As the asset security object may contain policy information one example of this may be a JavaScript Object Notation (JSON) Web Token signed by the Relying Party in order to persist the object.
Asset Identifier: This a string which uniquely identifies the asset. For example, it could be a file Uniform Resource Locator (URL) or a Universally Unique Identity (UUID) representing a vehicle.
Asset Description A description of the asset, generally for display purposes.
Unlocking Identity This is an identifier, e.g. an eID-Me identifier, of the user who can unlock the asset.
Is Owner A boolean indicating whether the unlocking identity is the asset owner.
Wrapped Asset Unlock Key This is, for example, a 256 bit AES asset unlock key which is encrypted by the user's public key.
Key Identifier This is the key identifier (unique within the Retying Party domain) which references the key within the user's set of cryptographic keys that can decrypt the Asset Unlock Key.
Validity Start Time If present, this is the beginning of the time period from which the asset is allowed to be unlocked. Prior to this time, the Relying Party should not perform a request to the Unlocking Identity. This item and the Validity End Time are useful for applications that have booking periods.
Validity End Time If present, this is the end of the time period from which the asset is allowed to be unlocked. After this time, the Relying Party should not perform a request to the Unlocking Identity.
Pairing Code An optional pairing code for applications that need to perform an in-person transaction protected by a unique pairing code.

Federated Key Management

The following describes embodiments of the invention relating to federated key management, such as eID-Me Federated Key Management within the software application “eID-Me” provided by BluInk Ltd. of Ottawa, Ontario, Canada (www.bluink.ca/eid-me).

Public cryptography solves the problem of key distribution, by allowing public keys to be freely shared for secure messaging and signature verification without compromising the sensitive private key material. However, for public key cryptography to work well, the private keys must be carefully guarded. There are a number of problems around the management of private keys that have traditionally been very challenging to solve with both security and convenience: These include, but are not limited to:
Where are the private keys stored?
How are the keys protected?
How is access to a controlled?

Federated key management as established by the inventors offers an elegant solution to these problems. Whilst the following description refers to the eID-Me software application the embodiments of the invention may be applied to other applications in order to provide a powerful platform for secure management of private identity claims which can be accessed via federation protocols or in-person. With a few simple extensions a software application platform can also host private keys with the same security and convenience, enabling the following desirable properties:

Secure storage of private keys
Accessible from anywhere.
Accessing a key requires authentication.
Avoid creating a target (a central database of keys).
Easy and convenient for end users.

Accordingly, the federated key management concepts allows for providing a user with the ability to establish a connection between a predetermined device, e.g. a POS terminal, amongst multiple POS terminals by providing the POS terminal with a first portion of a pairing code which it broadcasts and a user's device with a second portion of the pairing code allowing the user's device to selectively pair to the POS terminal with the other portion of the matching pairing code. Accordingly, a secure connection between the user's device and a specific POS terminal can be established to facilitate a transaction and/or communications even when the environment is “crowded” with electronic devices and/or POS terminals.

Accordingly, the federated key management concepts allows for providing a user with the ability to establish a connection between a predetermined device, e.g. an asset, amongst multiple assets by providing the asset with a first portion of a pairing code which it broadcasts and a user's device with a second portion of the pairing code allowing the user's device to selectively pair to the asset with the other portion of the matching pairing code. Accordingly, a secure connection between the user's device and a specific asset can be established to facilitate a transaction, access to the asset, unlocking the asset, communications etc. even when the environment is “crowded” with electronic devices and/or assets.

SECURITY TOKEN MODEL Accordingly, eID-Me for example, uses federation protocols to exercise identity operations on the target owner's smartphone. This is very much a “security token” architectural design since there is only one place where the user's sensitive information is stored and it is something that the user carries with them. Table 1 compares the inventive security token, e.g. an eID-Me security token, against a traditional security token such as a smart card.

TABLE 1
Inventive Security Token Compared to Prior Art Smart Card

| Feature | Smart Card | eID-Me |
|---|---|---|
| Secure Storage of Private Keys | YES | YES |
| Accessible from Anywhere | NO | YES |
| User Authentication Required for Key Operations | YES | YES |
| Avoid Creating a Large Target for Attackers | YES | YES |
| Easy and Convenient for Users | NO | YES |

PROTOCOLS There are several protocols which can be used to perform Federated Key Management with a software application such as eID-Me. These include, but are not limited to, OpenID Connect, Security Assertion Markup Language (SAML), and In-Person.

KEY MANAGEMENT OBJECT IDENTIFIERS (OIDS) The use of object identifiers (OIDs) for key operations allows Relying Parties to request a key operation using the same protocols as regular identity claim operations. Accordingly, embodiments of the invention exploit OIDs to reference asymmetric key operations such as for the Asymmetric Private Key and the Asymmetric Public Key. These OIDs are actually used as prefixes to keys and key operations. On their own, the OIDs do nothing. They must be qualified with an operation and accompanying metadata.

DOMAINS AND KEY IDENTIFIERS It is also a requirement that multiple keys be managed in such a way that different Relying Parties can reference keys associated with their service without collision with keys from another Relying Party. Furthermore, each Relying Party may have multiple keys for various purposes. To do this, a Relying Party would define different key identifiers for different purposes. Conceptually, a fully qualified key reference would be the following:

<Key Management OID>.<domain>.<key id>

Where <domain> is the Relying Party unique identifier, and <key id> is the key identifier assigned by the Relying Party. As the Relying Party unique identifier is, within embodiments of the invention, always pan of a request message, e.g. eID-Me request message, the Relying Party only needs to specify the <key id> to uniquely reference a key.

Separation of Domains The software application, e.g. eID-Me smartphone software application, enforces the separation of keys by Relying Party domain. Accordingly, it is not possible for a Relying Party to request a key operation for a key belonging to another Relying Party domain.

Implied Key Identity Diversification by User It is worth noting that <key id> identifiers do not need to be different for different users, e.g. eID-Me users. Since a key is bound to the owner of the identity, e.g. an eID-Me identity, Reply Parties do not need to diversify key identifiers by user. The automatic key binding provided by the software application, e.g. eID-Me, should simplify how Relying Parties implement their services.

KEY REFERENCE EXAMPLE A secure messaging service that wants a user to digitally sign a message could do it by referencing the private key of the user as follows:

<asymmetric private key OID>

Signing_Key

The software application would then find the key, for example, using the scheme:

<asymmetric private key OID>.<Relying Party UUID>.Signing_Key

Where <Relying Party UUID> is the unique identifier of the secure messaging service. “Signing_Key” can be used for any user of the service. If the same messaging service wanted to allow a user to decrypt a message, it could reference the private decryption key as follows:

<asymmetric private key OID>

Decryption Key

The Relying Party only needs to maintain two key identifiers (Signing_Key and Decryption_Key) across its service for all users.

KEY OPERATIONS As stated earlier, referencing a particular key belonging to a user is not sufficient to perform a particular operation. The operation is specified in an “Op” parameter in a Federated Key Management request. The following key operations may be defined for such requests:
generate_key_pair The generate_key_pair operation requests the generation of an asymmetric key pair. An additional “Algo” parameter would specify the particular algorithm to use. Upon completion of this request, the response includes the exported public key.
export_public_key The export_public_key operation exports the pubic key and returns in the response. If a key pair does not exist, it is generated first. An additional “Algo” parameter specifies the key algorithm, which is ignored if the key exists.
delete_key The delete key deletes the referenced key pair. Either the asymmetric_public_key or asymmetric_private_key OID can be used within the request. In either case, both the private and public keys will be deleted (assuming the user approves the request).
unwrap The unwrap operation is a private key decrypt operation. The operation is further qualified by the “Algo” parameter to specify the algorithm details. The asymmetric_private_key OID must be used in the key reference. An accompanying payload is also provided in the request in a “Payload” parameter.
sign The sign operation generates a digital signature. The “Algo” parameter specifies the algorithm details and the “Payload” parameter carries the data to be signed. The key OID must be used in the key reference.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of secure asset sharing, comprising
providing a locked asset;
receiving a request to access the locked asset;
providing a key to access the locked asset; and
accessing the locked asset with the key.

2. The method according to claim 1, wherein
providing the locked asset comprises:
storing a locked asset upon a server connected to a communications network, the locked asset comprising an encrypted version of an asset which was encrypted with the key; and
storing in association with the locked asset an encrypted version of the key and an identity of an owner of the asset;
receiving a request to access the locked asset comprises:
receiving from a requestor within a first software application in execution upon a first electronic device a request to access the locked asset, the first electronic device associated with the requestor;
transmitting to the owner of the asset a first electronic message via the communications network, the first message comprising first data relating to an identification of the locked asset, the encrypted key, and second data relating to an identification of the requestor; and
displaying within a graphical user interface of a second software application in execution upon a second electronic device the first data and the second data together with a button relating to an approval of the owner of the asset for the requestor to access the locked asset, the second electronic device associated with the owner of the asset; and
providing the key to access the locked asset comprises:
determining whether the owner of the asset has approved the requestor's request to access the locked asset;
upon a positive determination the owner of the asset has approved the requestor's request to access the locked asset performing the steps of:
decrypting the encrypted version of the key with a decryption key associated with the owner of the asset to regenerate the key; and
transmitting a second electronic message via the communications network from the second electronic device to the first electronic device, the second electronic message comprising the key.

3. The method according to claim 2, wherein
the locked asset comprises an item of electronic content.

4. The method according to claim 2, further comprising
unlocking the locked asset by decrypting the locked asset with the key received in the second electronic message.

5. The method according to claim 2, wherein
the key is permanent allowing subsequent access at any point in time by the requestor.

6. The method according to claim 2, wherein
the key is temporary allowing access for a limited time period by the requestor.

7. The method according to claim 2, wherein
the key is temporary allowing one-time access by the requestor.

8. The method according to claim 2, wherein
the key is temporary allowing access for a limited number of accesses by the requestor.

9. The method according to claim 1, further comprising
providing within a server coupled to a communications network a software application for managing access to the asset; wherein
providing the locked asset comprises:
providing a first electronic device comprising a wireless interface operating according to a predetermined protocol, the first electronic device forming part of or attached to an asset and coupled to the communications network;
receiving a request to access the locked asset comprises:
receiving a request from a requestor relating to accessing the asset at a predetermined time;
transmitting from the server to the first device first data relating to predetermined time and second data relating to a pairing code for establishing a secure connection between the first electronic device and a second electronic device associated with the requestor, the second electronic device comprising a wireless interface operating according to the predetermined protocol; and
transmitting from the server to the second electronic device third data relating to the pairing code and fourth data relating to a key to access the asset; and
accessing the locked asset with the key comprises:
transmitting from the first electronic device at the predetermined time an advertisement advertising its presence;
monitoring with the second electronic device for the advertisement from the first device;
determining whether the advertisement from the first electronic device is received by the second electronic device and upon a positive determination providing an indication to a user of the second electronic device;
receiving from the user of the second electronic device the third data relating to the pairing code; and
establishing a secure connection between the first electronic device and the second electronic device in dependence upon the second data relating to the pairing code and the third data relating to the pairing code relating to the same pairing code;
transmitting to the first electronic device from the second electronic device the key;
validating the key upon the second electronic device; and
upon determinations of a valid key performing a predetermined action with respect to the asset.

10. The method according to claim 9, wherein
the predetermined action is unlocking of a lock associated with the asset.

11. The method according to claim 9, wherein
the asset is one of a lock, a vehicle, an electronic device, and an item of electronic content.

12. The method according to claim 9, wherein
the first electronic device is a Universal Serial Bus (USB) device.

13. The method according to claim 9, wherein
the predetermined action is establishment of secure communications between the second electronic device and at least one of the first electronic device and the asset.

14. The method according to claim 9, wherein
the key is permanent allowing subsequent access at any point in time by the requestor.

15. The method according to claim 9, wherein
the key is temporary allowing access for a limited time period by the requestor.

16. The method according to claim 9, wherein
the key is temporary allowing one-time access by the requestor.

17. The method according to claim 9, wherein
the key is temporary allowing access for a limited number of accesses by the requestor.
